(19) United States
(12) Patent Application Publication
(10) Pub. No.: US 2007/0245232 A1
(43) Pub. Date: Oct. 18, 2007

(54) Apparatus for Processing Documents That Use a Mark Up Language

(76) Inventors: Nobuaki Wake, Kitajima-cho (JP); Norio Oshima, Kitajima-cho (JP); Yusuke Fujimaki, Fujinomiya (JP); Masayuki Hiyama, Meguro-ku (JP)

Correspondence Address: SUGHRUE MION, PLLC, 2100 PENNSYLVANIA AVENUE, N.W., SUITE 800, WASHINGTON, DC, 20037, US

(21) Appl. No.: 11/578,127

(22) PCT Filed: Apr. 8, 2005
(86) PCT No.: PCT/JP05/07290

§ 371 Date: Oct. 10, 2006

Related U.S. Application Data
(60) Provisional application No. 60/592,369, filed on Aug. 2, 2004.

(30) Foreign Application Priority Data
Apr. 8, 2004 (JP) 2004-114529
Jan. 27, 2005 (JP) 2005-020456

(51) Int. Cl. G06F 17/00

(52) U.S. Cl. 715/513

(57) ABSTRACT

Document processing apparatus for processing a document described in a plurality of markup languages, represented by tag sets and by using plug-ins, such as an HTML unit and an SVG unit. In case a document to be processed is described in a plurality of tag sets, the document selects a processing system, which can process an element included in the document based on the element name and namespace of the element. The selected processing system sequentially determines, from the element toward the descendants of the element, whether elements can be processed, and when there is an element, which cannot be processed, the processing system delegates processing of the element to another processing system. Thus, an appropriate processing system to each element is dispatched.

### TECHNICAL FIELD

The present invention relates to a document processing technology, and it particularly relates to techniques processing a document described in a markup language.

### BACKGROUND TECHNOLOGY

The advent of the Internet has resulted in a near exponential increase in the number of documents processed and managed by users. The World Wide Web (also known as the Web), which forms the core of the Internet, includes a large data repository of such documents. In addition to the documents, the Web provides information retrieval systems for such documents. These documents are often formatted in markup languages, a simple and popular one being Hypertext Markup Language (HTML). Such documents also include links to other documents, possibly located in other parts of the Web. An Extensible Markup Language (XML) is another more advanced and popular markup language. Simple browsers for accessing and viewing the documents via the Web are developed in an object-oriented programming languages, such as Java.

Documents formatted in markup languages are typically represented in browsers and other applications in the form of a tree data structure. Such a representation corresponds to a parse tree of the document. The Document Object Model (DOM) is a well-known tree-based data structure model used for representing and manipulating documents. The document object model provides a standard set of objects for representing documents, including HTML and XML documents. The DOM includes two basic components, a standard model of how the objects that represent components in the documents can be combined, and a standard interface for accessing and manipulating them.

Application developers can support the DOM as an interface to their own specific data structures and application program interfaces (APIs). On the other hand, application developers creating documents can use standard DOM interfaces rather than interfaces specific to their own APIs. Thus, based on its ability to provide a standard, the DOM is effective to increase the interoperability of documents in various environments, particularly on the Web. Several variation of the DOM have been defined and are used by different programming environments and applications.

A DOM tree is a hierarchical representation of a document based on the contents of the corresponding DOM. The DOM tree includes a “root,” and one or more “nodes” arising from the root. In some cases, the root represents the entire document. Intermediate nodes could represent elements such as a table and the rows and columns in that table, for example. The “leaves” of the DOM tree usually represent data, such as text items or images that are not further decomposable. Each node in the DOM tree can be associated with attributes that describe parameters of the element represented by the node, such as font, size, color, indentation, etc.

HTML, while being a commonly used language for creating documents, is a formatting and layout language. HTML is not a data description language. The nodes of a DOM tree that represents an HTML document comprise predefined elements that correspond to HTML formatting tags. Since HTML normally does not provide any data description nor any tagging/labeling of data, it is often difficult to formulate queries for data in an HTML document.

A goal of network designers is to allow Web documents to be queried or processed by software applications. Hierarchically organized languages that are display-independent can be queried and processed in such a manner. Markup languages, such as XML (extensible Markup Language), can provide these features.

As opposed to HTML, a well known advantage of XML is that it allows a designer of a document to label data elements using freely definable “tags.” Such data elements can be organized hierarchically. In addition, an XML document can contain a Document Type Definition (DTD), which is a description of the “grammar” (the tags and their interrelationship) used in the document. In order to define display methods of structured XML documents, CSS (Cascading Style Sheets) or XSL (XML style Language) are used. Additional information concerning DOM, HTML, XML, CSS, XSL and related language features can be also obtained from the Web, for example, at http://www.w3.org/TR/.

Xpath provides common syntax and semantics for addressing parts of an XML document. An example of the functionality of Xpath is the traversing of a DOM tree corresponding to an XML document. It provides basic facilities for manipulation of strings, numbers and Booleans characters that are associated with the various representations of the XML document. Xpath operates on the abstract, logical structure of an XML document, for example the DOM tree, rather than its surface syntax, for example a syntax of which line or which character position in a sequence. Using Xpath one can navigate through the hierarchical structure, for example, in a DOM tree of an XML document. In addition to its use for addressing, Xpath is also designed to be used for testing whether or not a node in a DOM tree matches a pattern.

Additional details regarding Xpath can be found in http://www.w3.org/TR/xpath.

Given the advantages and features already known for XML, there is a need for an effective document processing and management system that can handle documents in a markup language, for example XML, and provide a user friendly interface for creating and modifying the documents. Extensive Markup Language (XML) is particularly suited as a format for compound documents or for cases where data related to a document is used in common with data for other documents via a network and the like. Many applications for creating, displaying and editing the XML documents have been developed (see, for example, Japanese Patent Application Laid Open No. 2001-290804).

The vocabulary may be defined arbitrarily. In theory, therefore, there may exist an infinite number of vocabularies. However, it does not serve any practical purpose to provide display/edit environments for exclusive-use with these vocabularies individually. In the related art, in a case of a document described in a vocabulary that is not provided with a dedicated edit environment, the source of a document composed of text data is directly edited using a text editor and the like.

Existing applications that can handle XML documents are available in the marketplace, but have significant limitations and encounter barriers that prevent wide scale acceptance. The method and device described herein solves the problems that have not heretofore been addressed by such existing products and their underlying existing technologies.

For example, in the implementation of an existing XML document processing device, the characteristic of an XML document as an expression of the content that is not relevant to the method of its display can be viewed superficially as an advantage. However, such feature is actually disadvantageous in that the user may not edit it directly. To solve this problem, the existing XML document processing product specifically designs the screen for the XML input. However, the flexibility of the screen design is limited, in that the existing XML product must be hard coded beforehand.

In view of this limitation, XSLT previously was developed as one of the standards of the Style Sheet language. It is a technology that can free a user from hard coding, and is compatible with the applicable methods of displaying XML documents. However, XSLT does not make it possible to edit a XML document only by displaying it.

Moreover, existing XML products primarily rely on the placement of “Schema.” Therefore, once the scheme is decided first, there is a restriction that only the XML document that corresponding to the schema structure from a top level can be handled. In other words, the system is a rigid system.

### DISCLOSURE OF THE INVENTION

In accordance with the present invention, the foregoing restrictions are not present. The structure of the entire XML document need not be rigidly decided. The compound XML document with various structures can be safely treated by the idea of dividing the XML document into some parts, and dispatching it to an edit module, preferably represented by a plug-in, so that a flexible system can be achieved. Further, a flexible screen design can be implemented by the user without the restriction of hard coding, and can be edited using WYSIWYG.

The present invention has been made in view of the foregoing circumstances and, accordingly, provides a method and apparatus for effectively processing a document that is described in one or more markup languages, for example, an XML-type language.

Some of the exemplary embodiments of the invention relate to document processing apparatus, for example, a document processing apparatus that comprises a plurality of processing units, each of which processes a common document described in a specific tag set and is adapted to display a document described in plural types of tag sets on a common display medium, such as a common display screen, by way of the processing unit corresponding to each tag set in order to accept editing of the document by a user.

The present invention also relates to a document processing method, particularly a document processing method that displays a document described using plural types of tag sets on a common display medium, such as a common display screen, by way of a processing part that corresponds to a respective tag set, in order to accept editing of the document by a user.

It is noted herein that any arbitrary combinations of the above-described structural components and expressions changed between a method, apparatus, a system and so forth are all effective as the embodiments of the invention.

According to the invention, it is possible to provide processing units or processing parts for effectively processing a compound document described in one or more markup languages, for at least one or more of the purposes of generation, editing, display and/or storage.

### BRIEF DESCRIPTION OF THE DRAWINGS

FIG. 1 illustrates in block diagram form a document processing apparatus according to an exemplary but non-limiting embodiment of the present invention.

FIG. 2 illustrates an example of an XML document.

FIG. 3 illustrates an example in which the XML document of FIG. 2 is mapped to a table described in HTML.

FIG. 4 illustrates an example of a definition file to map the XML document of FIG. 2 to the table of FIG. 3.

FIG. 5 illustrates an example of a display screen when the XML document of FIG. 2 is mapped to HML using the correspondence of FIG. 3.

FIG. 6 illustrates a graphical user interface useable with the present invention.

FIG. 7 illustrates a further example of a screen layout generated in accordance with the present invention.

FIG. 8 illustrates an edit screen for XML documents, in accordance with the present invention.

FIG. 9 illustrates another example of an XML document edited according to the present invention.

FIG. 10 illustrates an edit screen useable with the present invention.

FIG. 11(a) illustrates a conventional arrangement of components that can serve as the basis of an exemplary implementation of the disclosed document processing and management system.

FIGS. 11(b) and 11(c) show an overall block diagram of an exemplary document processing and management system.

FIG. 12 shows further details of an exemplary implementation of the document manager.

FIG. 13 shows further details of an exemplary implementation of the vocabulary connection subsystem 300.

FIG. 14(a) shows further details of an exemplary implementations of the program invoker and its relation with other components.

FIG. 14(b) shows further details of an exemplary implementation of the service broker and its relation to other components.

FIG. 14(c) shows further details of an exemplary implementation of services.

FIG. 14(d) shows examples of services.

FIG. 14(e) shows further details on the relationships between the program invoker and the user application.

FIG. 15(a) provides further details on the structure of an application service loaded onto the program invoker.

FIG. 15(b) shows an example of the relationships between a frame, a menu bar and a status bar.

FIG. 16(a) shows further details related to an exemplary implementation of the application core.

FIG. 16(b) shows further details related to an exemplary implementation of a snap shot.

FIG. 17(a) shows further details related to an exemplary implementation of the document manager.

FIG. 17(b) shows, in the right side, an example of how a set of documents A-E are arranged in a hierarchy, and in the left side, an example of how the hierarchy of documents shown in the right side appears on a screen.

FIGS. 18(a) and 18(b) provide further details of an exemplary implementation of the undo framework and undo command.

FIG. 19(a) shows an overview of how a document is loaded in the document processing and management system shown in FIGS. 11(b)-(c).

FIG. 19(b) shows a summary of the structure for the zone, using the MVC paradigm.

FIG. 20 shows an example of a document and its various representations in accordance with the present invention.

FIG. 21(a) shows a simplified view of the Mv relationship for the XHTML component of the document shown in FIG. 20.

FIG. 21(b) shows a vocabulary connection for the document shown in FIG. 21(a).

FIGS. 22(a)-22(c) show further details related to exemplary implementations of the plug-in sub-system, vocabulary connections and connector, respectively.

FIG. 23 shows an example of a VCD script using vocabulary connection manager and the connector factory tree for a file MySampleXML.

FIGS. 24(a)-(c) show steps 0-3 of loading the example document MySampleXML into the exemplary document processing and management system of FIG. 11(b).

FIG. 25 shows step 4 of loading the example document MySampleXML into the exemplary document processing and management system of FIG. 11(b).

FIG. 26 shows step 5 of loading the example document MySampleXML into the exemplary document processing and management system of FIG. 11(b).

FIG. 27 shows step 6 of loading the example document MySampleXML into the exemplary document processing and management system of FIG. 11(b).

FIG. 28 shows step 7 of loading the example document MySampleXML into the exemplary document processing and management system of FIG. 11(b).

FIG. 29(a) shows a flow of an event which has taken place on a node having no corresponding source node and dependent on a destination tree alone.

FIG. 29(b) shows a flow of an event which has taken place on a node of a destination tree which is associated with a source node by TextOfConnector.

### BEST MODE FOR CARRYING OUT THE INVENTION

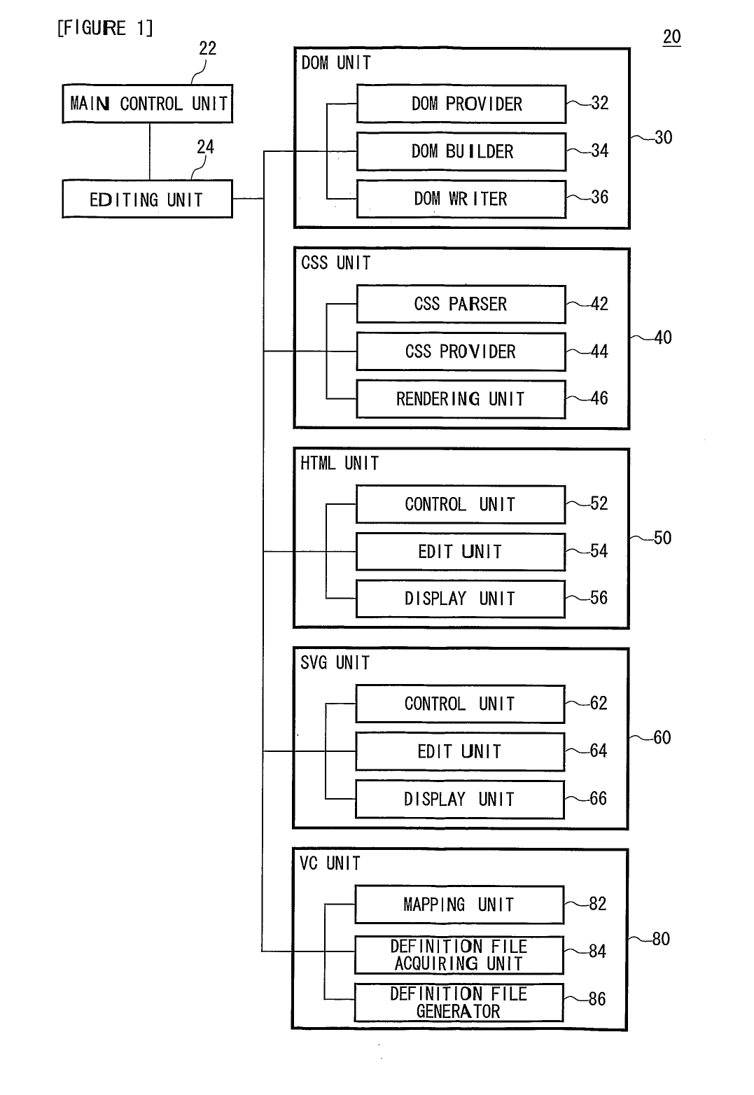

FIG. 1 illustrates a structure of a document processing apparatus 20 according to an exemplary but non-limiting embodiment of the present invention. The document processing apparatus 20 processes a structured document where data in the document are classified into a plurality of components having a hierarchical structure. Represented in the present embodiment is an example in which an XML document, as one type of a structured document, is processed. The document processing apparatus 20 is comprised of a main control unit 22, an editing unit 24, a DOM (Document Object Model) unit 30, a CSS (Cascade Style Sheets) unit 40, an HTML (HyperText Markup Language) unit 50, an SVG (Scalable Vector Graphics) unit 60 and a VC (Vocabulary Connection) unit 80 which serves as an example of a conversion unit. In terms of hardware components, these unit structures may be realized by any conventional processing system or equipment, including a CPU or memory of an arbitrary computer, a memory-loaded program, a hardwired chip or the like. Accordingly, drawn and described herein are function blocks in an exemplary arrangement that are or may be realized in any such processing system, as would be understood by one skilled in the art. Thus, it would be understood by those skilled in the art that these function blocks can be realized in a variety of forms by hardware only, software only or the combination thereof.

The main control unit 22 provides for the loading of a plug-in or a framework for executing a command. The editing unit 24 provides a framework for editing XML documents. Display and editing functions of a document in the document processing apparatus 20 is realized by plug-ins, and the necessary plug-ins are loaded by the main control unit 22 or the editing unit 24 according to the type of document under consideration. The main control unit 22 or the editing unit 24 determines which one or more vocabulary describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents using a control unit 52, an edit unit 54 and a display unit 56, and an SVG unit 60, which displays and edits SVG documents using a control unit 62, an edit unit 64 and a display unit 66, are implemented as processing units in the document processing apparatus 20. That is, a display system and an editing system are implemented as plug-ins for each vocabulary (tag set), so that the HTML unit 50 and the SVG unit 60 are loaded in cooperation with their respective control unit, when an HTML document and a SVG document are edited, respectively. As will be described later, when compound documents, which contain both the HTML and SVG components, are to be processed, both the HTML unit 50 and the SVG unit 60 are loaded.

By implementing the above structure, a user can select necessary functions only so as to be installed and can add or delete a function or functions at a later stage, as appropriate. Thus, the storage area of a recording medium, such as a hard disk, can be effectively utilized, and the wasteful use of memories can be prevented at the time of executing programs. Furthermore, since this structure excels in expanding the capability thereof, a developer himself/herself can deal with new vocabularies in the form of plug-ins and, thus, the development process can be readily facilitated. As a result, the user can also add a function or functions easily at low cost by adding a plug-in or plug-ins.

The editing unit 24 receives, via an interface, including but not limited to input actions such as a mouse click or key stoke, an event (a triggering event) of an editing instruction from a user, conveys an event to an appropriate plug-in and controls the processings, which may include a redo processing to re-execute the event and an undo processing to cancel the event.

The DOM unit 30 includes a DOM provider 32, a DOM builder 34 and a DOM writer 36. The DOM unit 30 realizes functions in compliance with a document object model (DOM), which is defined to provide an access method when XML documents are handled as data. The DOM provider 32 is an implementation of a DOM that satisfies an interface defined by the editing unit 24. The DOM builder 34 generates DOM trees from XML documents. As will be described later, when an XML document to be processed is mapped to other vocabulary by the VC unit 80, a source tree, which corresponds to the XML document in a mapping source, and a destination tree, which corresponds to the XML document in a mapping destination, are generated. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs a CSS cascade processing on the DOM tree. The rendering unit 46 is a rendering engine of CSS and is used to display documents, described in a vocabulary such as HTML, which are laid out using CSS.

The HTML unit 50 displays or edits documents described in HTML. The SVG unit 60 displays or edits documents described in SVG. These display/edit systems are realized in the form of plug-ins, and each system is comprised of a display unit (also designated herein as “canvas”), which displays documents, a control unit (also designated herein as an “editlet”), which transmits and receives events containing editing commands, and an edit unit (also designated herein as a “zone”), which edits the DOM upon receipt of the editing commands. When the control unit receives from an external source an editing command for the DOM tree, the edit unit modifies the DOM tree and the display unit updates the display. These units are of a structure similar to a framework called an MVC (Model-View-Controller), which is a well-known graphical user interface (GUI) paradigm. The MVC paradigm offers a way of breaking an application, or even just a piece of an application's interface, into three parts: the model, the view, and the controller. MVC was originally developed to map the traditional input, processing and output roles into the GUI realm.
Input→Processing→Output
Controller→Model→View

According to the MVC paradigm, the user input, the modeling of the external world, and the visual feedback to the user are separated and handled by model (M), viewport (V) and controller (C) objects. The controller is operative to interpret inputs, such as mouse and keyboard inputs from the user, and map these user actions into commands that are sent to the model and/or viewport to effect an appropriate change. The model is operative to manage one or more data elements, respond to queries about its state, and respond to instructions to change state. The viewport is operative to manage a rectangular area of a display, and is responsible for presenting data to the user through a combination of graphics and text.

In general, according to the exemplary embodiments of the present invention disclosed herein, the display unit (V) corresponds to “View”, the control unit (C)corresponds to “Controller”, and the edit unit and DOM entity (M) correspond to “Model”. In the document processing apparatus 20 according to the present exemplary embodiment of FIGS. 1-10, not only is the XML document edited in the tree-view display format, but also the editing can be done according to the respective vocabularies. For example, the HTML unit 50 provides a user interface by which to edit the HTML documents by a method similar to that of a word processor, whereas the SVG unit 60 provides a user interface by which to edit the SVG documents by a method similar to that of an image drawing tool.

The VC unit 80 includes a mapping unit 82, a definition file acquiring unit 84 and a definition file generator 86. By mapping a document described in a certain vocabulary to another vocabulary, the VC unit 80 provides a framework to display or edit the document by a display and editing plug-in corresponding to the vocabulary that is mapped. In the present embodiment, this function is called a vocabulary connection (VC). In the VC unit 80, the definition file acquiring unit 84 acquires a definition file in which the definition of a mapping is described. In this embodiment, the definition file is a script file.

The document in the first vocabulary is represented as a source tree with nodes. Likewise, in the second vocabulary it is represented as a destination tree with nodes. The definition file describes connection between nodes in the source tree and the destination tree, for each node. As is known in the W3C art, nodes in a DOM tree may be defined according to element values and/or attribute values. In this embodiment, it may be specified whether element values or attribute values of the respective nodes are editable or not.

Further, in this embodiment, operation expressions using the element values or attribute values of nodes may also be described. These functions will be described later. The mapping unit 82 causes the DOM builder 34 to generate the destination tree by referring to the definition file (script file) that the definition file acquiring unit 84 has acquired, so that the mapping unit 82 manages the correspondence relationships between source trees and destination trees. The definition file generator 86 provides a graphical user interface for the user to generate a definition file.

The VC unit 80 monitors the connection between the source tree and the destination tree. When the VC unit 80 receives an editing instruction from a user via a user interface provided by a plug-in that is in charge of displaying, it first modifies a relevant node of the source tree. As a result, the DOM unit 30 will issue a mutation event indicating that the source tree has been modified. Then, the VC unit 80 receives the mutation event and modifies a node of the destination tree corresponding to the modified node in order to synchronize the destination tree with the modification of the source tree When a plug-in for providing the processing necessary to displaying/editing the destination tree, such as an HTML unit 50, receives a mutation event indicating that the destination tree has been modified, the plug-in updates a display by referring to the modified destination tree. By implementing such a structure in which the vocabulary is converted to another major vocabulary, a document can be displayed properly and a desirable editing environment can be accordingly provided, even if the document is described in a local vocabulary utilized by a small number of users.

An operation in which the document processing apparatus 20 displays and/or edits documents will be described herein below. When the document processing apparatus 20 loads a document to be processed, the DOM builder 34 generates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed therein, a check shall be made to see whether a definition file exists or not. And if the definition file exits, the definition file acquiring unit 84 acquires the definition file and generates a destination tree according to the definition, so that the document is displayed/edited by the plug-in corresponding to the vocabulary mapped. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out in the display screen.

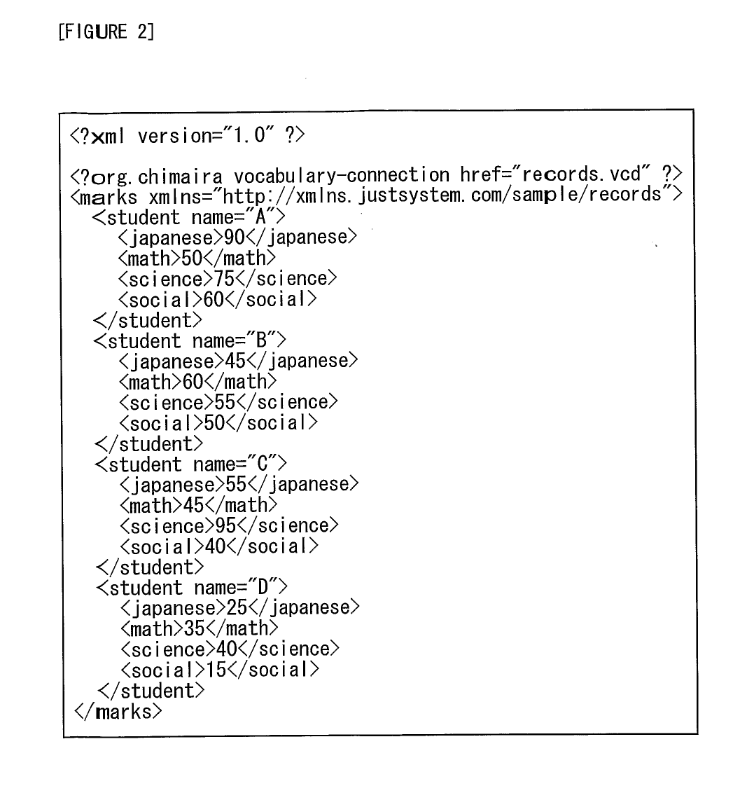

FIG. 2 shows an example of an XML document to be processed. According to this exemplary illustration, the XML document is used to manage data concerning grades or marks that students have earned. A component “marks”, which is the top node of the XML document, includes a plurality of components “student” provided for each student under “marks”. The component “student” has an attribute “name” and contains, as child elements, the subjects that are “Japanese”, “Math” (mathematics), “Science”, and “Social” (social studies). The attribute “name” stores the name of a student; The components “Japanese”, “Math”, “Science” and “Social” store the test scores of the subjects, which are Japanese, mathematics, science, and social studies, respectively. For example, the marks of a student whose name is “A” is “90” for Japanese, “50” for mathematics, “75” for science and “60” for social studies. Hereinafter, the vocabulary (tag set) used in this document will be called “marks managing vocabulary”.

Since the document processing apparatus 20 according to the present exemplary embodiment does not have a plug-in which conforms to or handles the display/edit of marks managing vocabularies, the above-described VC facility 80 is used in order to display this document by a display method that does not use the source display and tree display. That is, it is necessary that a definition file be prepared so that the marks managing vocabulary may be mapped to another vocabulary, for example, HTML or SVG where a plug-in therefor has been prepared. Though a user interface required for a user himself/herself to create the definition file will be described later, the description is given herein below, assuming that the definition file has already been prepared.

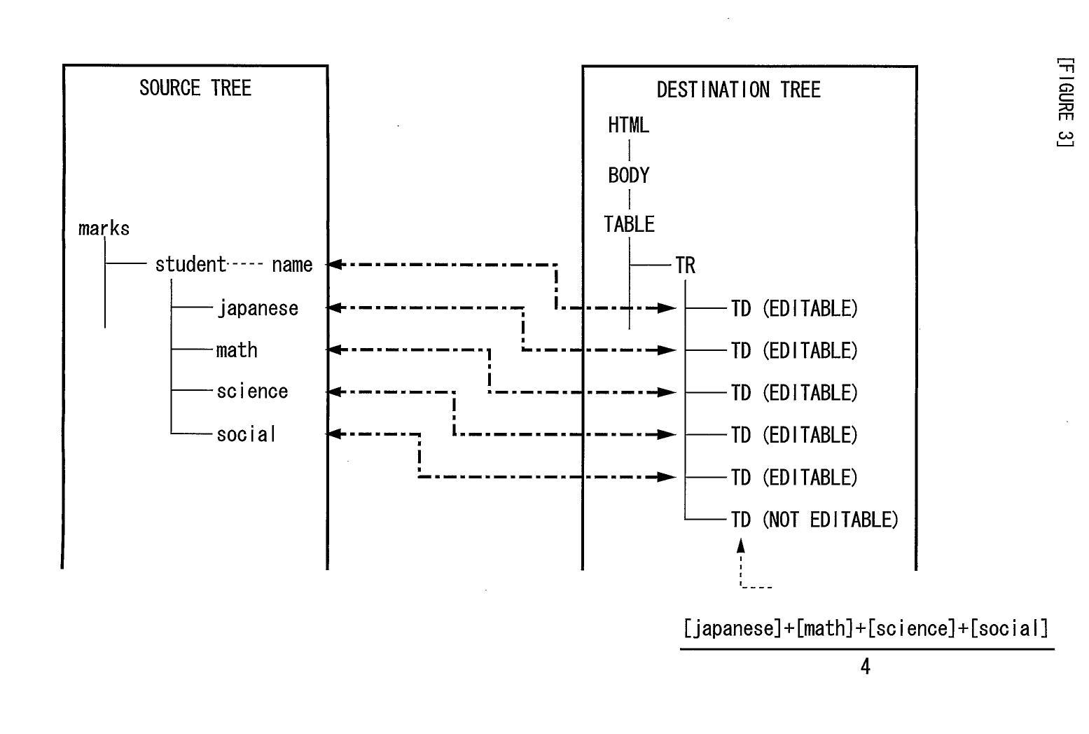

FIG. 3 shows an example in which the XML document shown in FIG. 2 is mapped to a table described in HTML. In an example shown in FIG. 3, a “student” node in the marks managing vocabulary is associated to a row (“TR” node) of a table in HTML (“TABLE” node). The first column in each row corresponds to an attribute value “name”, the second column to an element value of “Japanese” node, the third column to an element value of “Math” node, the fourth column to an element value of “Science” node and the fifth column to an element value of “Social” node. As a result, the XML document shown in FIG. 2 can be displayed in a tabular format of HTML. Furthermore, these attribute values and element values are designated as being editable, so that the user can edit these values on a display screen using an editing function of the HTML unit 50. In the sixth column, an operation expression by which to calculate a weighted average of marks for Japanese, mathematics, science and social studies is designated, and average values of the marks for each student are displayed. In this manner, more flexible display can be done by making it possible to specify the operation expression in the definition file, thus improving the users' convenience at the time of editing. In this example shown in FIG. 3, editing is designated as not possible in the sixth column, so that the average value alone cannot be edited individually. Thus, in the mapping definition it is possible to specify editing or no editing so as to protect the users against possible erroneous operations.

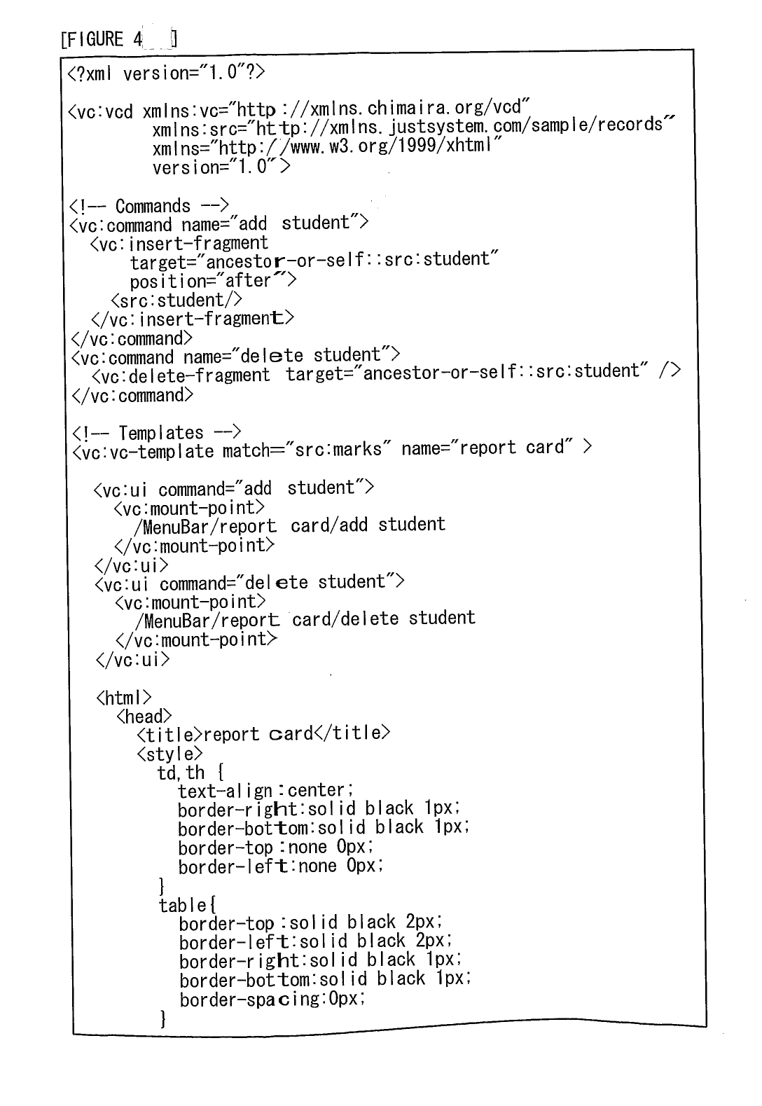

FIG. 4 illustrates an example of definition file to map the XML document shown in FIG. 2 to the table shown in FIG. 3. This definition file is described in script language defined for use with definition files. In the definition file, definitions of commands and templates for display are described. In the example shown in FIG. 4, “add student” and “delete student” are defined as commands, and an operation of inserting a node “student” into a source tree and an operation of deleting the node “student” from the source tree are associated thereto, respectively. A template describes that a header, such as “name” and “Japanese,” is displayed in the first row of a table and the contents of the node “student” are displayed in the second and subsequent rows. In the template displaying the contents of the node “student”, a term containing “text-of” indicates that editing is allowed, whereas a term containing “value-of” indicates that editing is not allowed. Among the rows where the contents of the node “student” are displayed, an operation expression “(src:japanese+src:math+scr:science+scr:social) div 4” is described in the sixth row. This means that the average of student's marks is displayed.

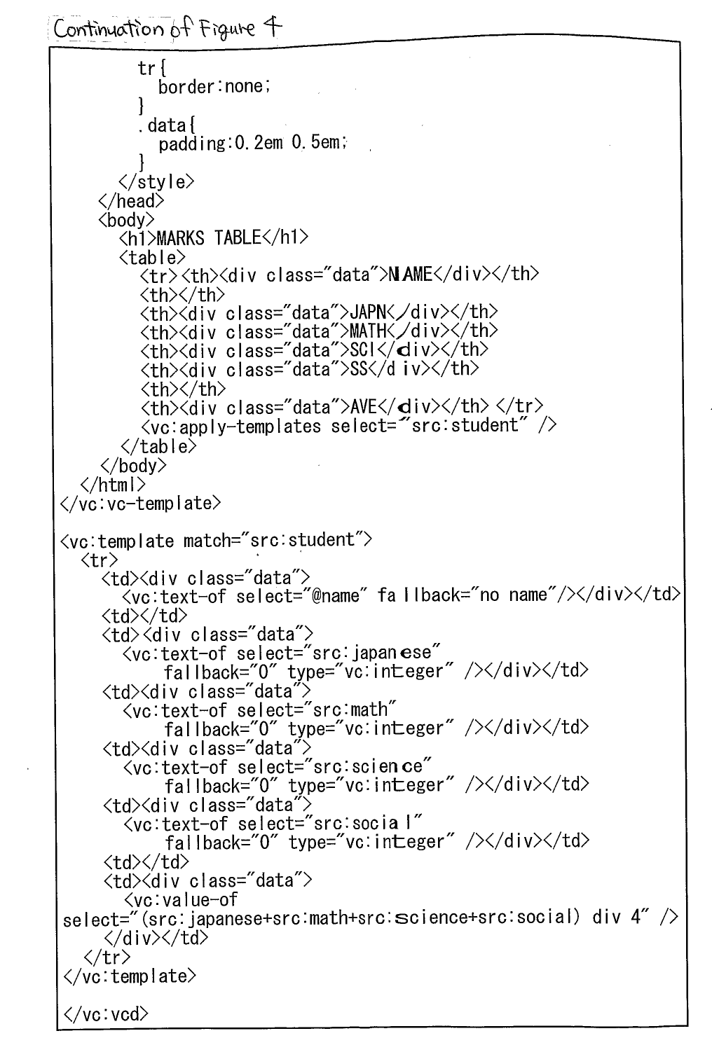

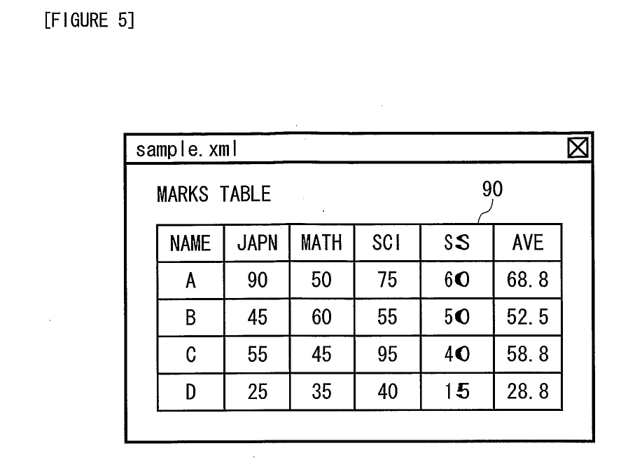

FIG. 5 shows an example of a display screen when the XML document described by the marks managing vocabulary shown in FIG. 2 is mapped to HTML using the correspondence shown in FIG. 3 so as to be displayed thereon. Displayed from left to right in each row of a table 90 are the name of each student, marks for Japanese, marks for mathematics, marks for science, marks for social studies and an average thereof. The user can edit the XML document on this screen. For example, when the value in the second row and the third column is changed to “70”, the element value in the source tree corresponding to this node, that is, the marks of student “B” for mathematics, is changed to “70”. At this time, in order to have the destination tree follow the source tree, a relevant portion of the destination tree is changed accordingly, so that the HTML unit 50 updates the display based on the thus changed destination tree. Hence, the marks of student “B” for mathematics is changed to “70”, and the average is changed to “5 5” accordingly.

On the screen as shown in FIG. 5, commands like “add student” and “delete student” are displayed in a menu as defined in the definition file shown in FIG. 4. When the user selects a command from among these commands, a node “student” is added or deleted in the source tree. In this manner, with the document processing apparatus 20 according to the present embodiment, it is possible not only to edit the element values of components in a lower end of a hierarchical structure but also to edit the hierarchical structure. An edit function having such a tree structure may be presented to the user in the form of commands. Furthermore, a command to add or delete rows of a table may, for example, be related to an operation of adding or deleting the node “student”. A command to embed other vocabularies therein may be presented to the user. This table may be used as an input template, so that marks data for new students can be added in a fill-in-the-blank format. As described above, documents described in the marks managing vocabulary can be edited by the VC function while utilizing the display/edit function of the HTML unit 50.

FIG. 6 shows an example of graphical user interface, which the definition file generator 86 presents to the user, in order for the user to generate a definition file. An XML document to be mapped is displayed in a tree in a left-hand area 91 of a screen. The screen layout of an XML document mapped is displayed in a right-hand area 92 of the screen. This screen layout can be edited by the HTML unit 50, and the user determines and creates a screen layout for displaying documents in the right-hand area 92 of the screen. For example, a node of the XML document, to be mapped, which is displayed in the left-hand area 91 of the screen, is dragged and dropped into the HTML screen layout in the left-hand area 91 of the screen using a pointing device such as a mouse, so that a connection between a node at a mapping source and a node at a mapping destination is specified. For example, when “math,” which is a child element of the element “student,” is dropped to the intersection of the first row and the third row in a table 90 on the HTML screen, a connection is established between the “math” node and a “TD” node in the third column. Each node is such t hat editing or no editing can be specified. Moreover, the operation expression can be embedded in a display screen. When the screen editing is completed, the definition file generator 86 generates definition files, which describe connections between the screen layout and nodes.

Viewers or editors, which can handle major vocabularies, such as XHTML (extensible HyperText Markup Language), MathML (Mathematical Markup Language) and SVG (Scalable Vector Graphics), have already been developed. However, it does not serve any practical purpose to develop viewers or editors that are suitable for all documents, such as one shown in FIG. 2, described in the original vocabularies. If, however, the definition files for mapping to other vocabularies are created as mentioned above, the documents described in the original vocabularies can be displayed and/or edited utilizing the VC function without ever developing a new viewer or editor.

FIG. 7 shows another example of a screen layout generated by the definition file generator 86. In the example shown in FIG. 7, a table 90 and circular graphs 92 are produced on a screen for displaying XML documents described in the marks managing vocabulary. The circular graphs 93 are described in SVG. As will be discussed late r, the document processing apparatus 20, according to the present exemplary embodiment, can process compound documents described in a plurality of vocabularies within a single XML document. That is why the table 90 described in HTML and the circular graphs 93 described in SVG can be displayed on a same screen.

FIG. 8 shows an example of a medium display, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95 and the table shown in FIG. 5 and described in HTML is displayed in an area 96. The document can be edited in any of these areas, and when the user edits a content in any of these areas, the source tree will be modified accordingly and then each plug-in in charge of each screen display updates the screen so as to effect the modification of the source tree. Specifically, display units of the plug-ins in charge of displaying the respective edit screens are registered in advance as listeners of mutation events that provide notice of a change in the source tree. When the source tree is modified by any of the plug-ins or the VC unit 80, all the display units, which are displaying the edit screen, receive the issued mutation event (s) and then update the screens. At this time, if the plug-in is performing the display through the VC function, the VC unit 80 modifies the destination tree by following the modification of the source tree. Thereafter, the display unit of the plug-in modifies the screen by referring to the thus modified destination tree.

For example, when the source display and tree-view display are realized by dedicated plug-ins, the source-display plug-in and the tree-display plug-in realize their display by directly referring to the source tree instead of using the destination tree. In this case, when the editing is done in any area of the screen, the source-display plug-in and the tree-display plug-in update the screen by referring to the modified source tree. Also, the HTML unit 50 in charge of displaying the area 96 updates the screen by referring to the destination tree, which has been modified following the modification of the source tree.

The source display and the tree-view display can also be realized by utilizing the VC function. That is, for example, if HTML is used for the layout of the source and tree structures, an XML document may be mapped to the HTML so as to be displayed by the HTML unit 50. In such a case, three destination trees in the source format, the tree format and the table format will be generated. If the editing is carried out in any of the three areas on the screen, the VC unit 80 modifies the source tree and, thereafter, modifies the three destination trees in the source format, the tree format and the table format, respectively. Then, the HTML unit 50 updates the three areas of the screen by referring to three destination trees.

In this manner, a document is displayed, on a single screen, in a plurality of display formats, thus improving a user's convenience. For example, the user can display and edit a document in a visually easy-to-understand format using the table 90 or the like while grasping a hierarchical structure of the document by the source display or the tree display. In the above example, a single screen is partitioned into a plurality of display formats, and they are displayed simultaneously. However, a single display format may be displayed on a single screen so that the display format can be switched by the user's instruction. In this case, the main control unit 22 receives from the user a request for switching the display format and then instructs the respective plug-ins to switch the display.

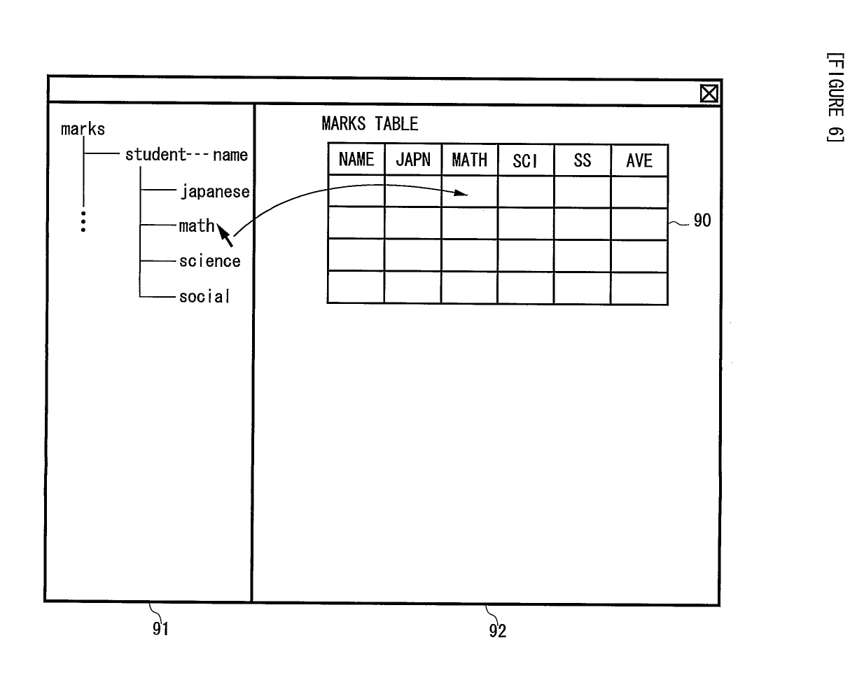

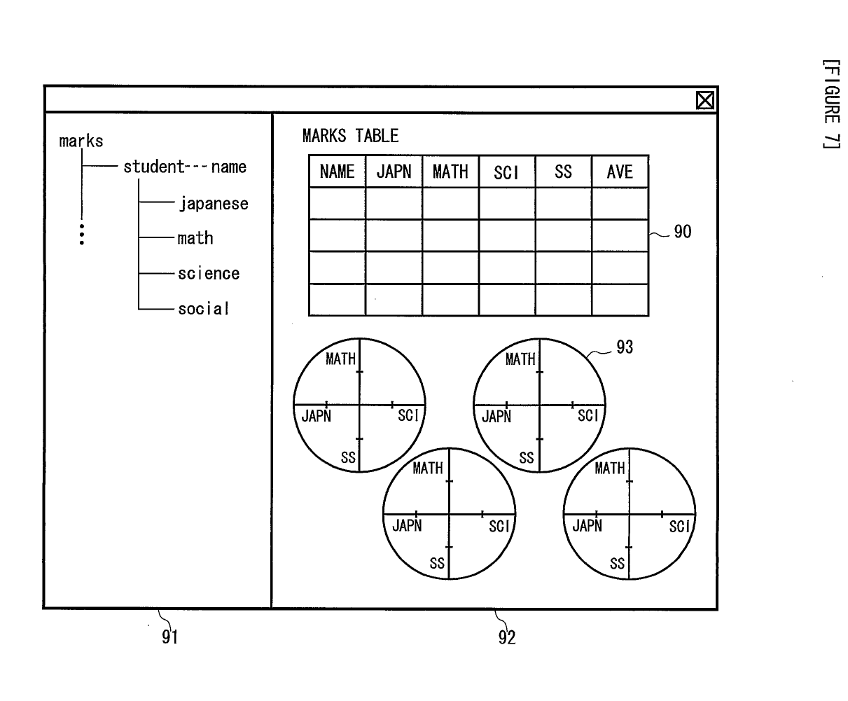

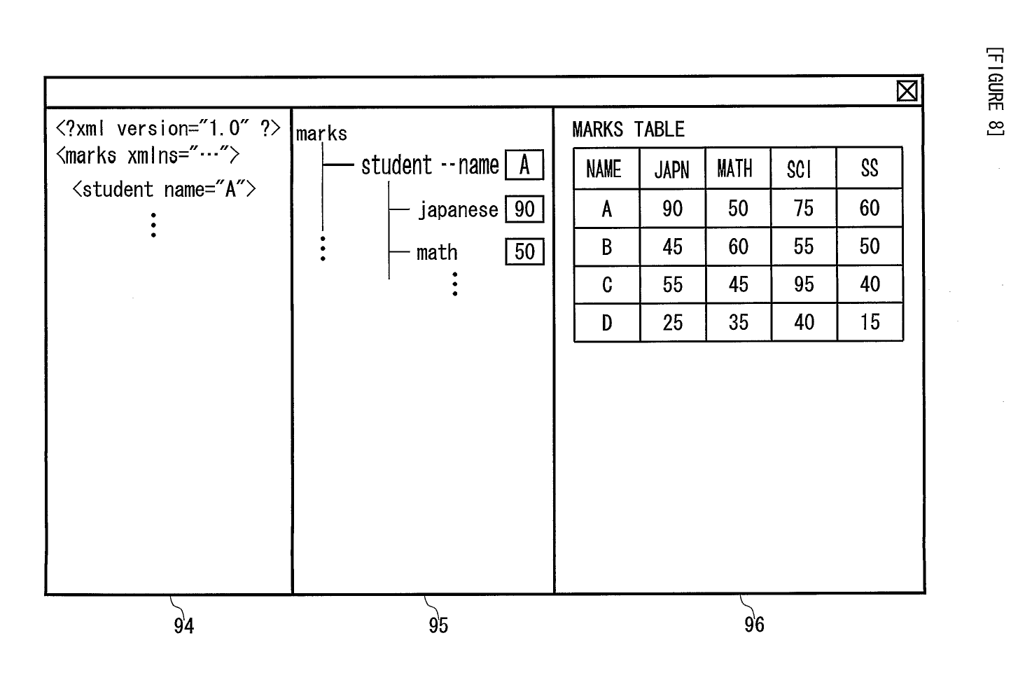

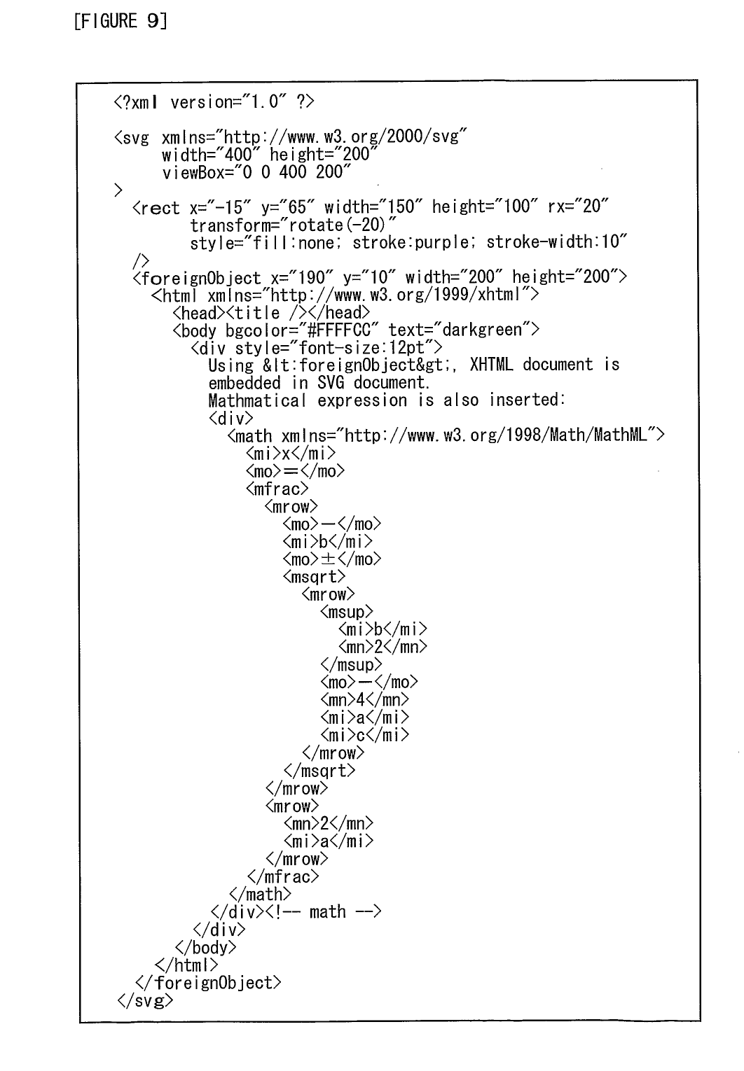

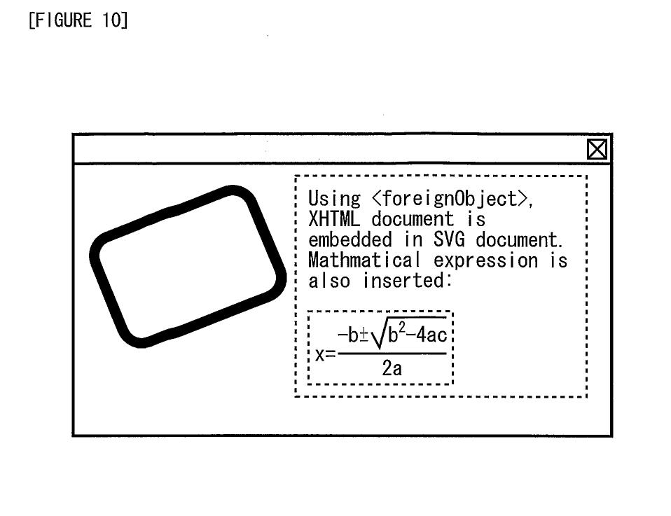

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 distributes or assigns the drawing job to an appropriate displaying system by referring to the name space. In the example illustrated in FIG. 9, the editing unit 24 first has the SVG unit 60 draw a rectangle, and then has the HTML unit 50 draw the XHTML document. Furthermore, the editing unit 24 has a MathML unit (not shown) draw an equation. In this manner, the compound document containing a plurality of vocabularies is appropriately displayed. FIG. 10 illustrates the resulting display.

During the editing of a document, an editing menu may be displayed to the user. The menu may correspond to the portion of the compound document that is to be edited. Thus, the menu to be displayed may be switched according to the position of a cursor (carriage) as it is moved by a user from location to location on a display medium. That is, when the cursor lies in an area where an SVG document is displayed, the menu present to the user is in response to the SVG unit 60 or a command defined by a definition file, which is used for mapping the SVG documents. When the cursor lies in an area where the XHTML document is displayed, the menu presented to the user is in response to the HTML unit 50 or a command defined by a definition file, which is used for mapping the XHTML documents. Thus, an appropriate user interface can be presented according to the editing position.

If in the compound document there does not exist an appropriate plug-in or mapping definition conforming to a vocabulary, a portion described in the vocabulary may be displayed in source or in tree format. In the conventional practice, when a compound document is to be opened where another document is embedded in a certain document, their contents cannot be displayed unless an application to display the embedded document is installed therein. According to the present embodiment, however, the XML documents, which are composed of text data, may be displayed in source or in tree format so that the contents thereof can be ascertained. This is a characteristic of the text-based XML documents or the like.

As another advantageous aspect of the data being described in a text-based language, for example, is that data on a part described in other vocabularies in the same document may be referenced for another part described in a certain vocabulary in the compound document. Furthermore, when a search is made within the document, a string of characters embedded in a drawing, such as SVG, may also be candidates to be searched.

In a document described in a certain vocabulary, tags belonging to other vocabularies may be used. Though this XML document is not valid in general, it can be processed as a valid XML document as long as it is well-formed. In such a case, the thus inserted tags that belong to other vocabularies may be mapped using a definition file. For instance, tags such as “Important” and “Most Important” may be used so as to display a portion surrounding these tags in an emphasized manner, or may be sorted out in the order of importance so as to be displayed accordingly.

When the user edits a document on an edit display, e.g., a screen as shown in FIG. 10, a plug-in or a VC unit 80, which is in charge of processing the edited portion, modifies the source tree. A listener for mutation events can be registered for each node in the source tree. Normally, a display unit of the plug-in or the VC unit 80 conforming to a vocabulary that belongs to each node is registered as the listener. When the source tree is modified, the DOM provider 32 traces toward a higher hierarchy from the modified node. If there is a registered listener, the DOM provider 32 issues a mutation event to the listener. For example, referring to the document shown in FIG. 9, if a node which lies lower than the <html> node is modified, the mutation event is notified to the HTML unit 50, which is registered as a listener to the <html> node. At the same time, the mutation event is also notified to the SVG unit 60, which is registered, as a listener, in a <svg> node, which lies upper to the <html> node. At this time, the HTML unit 50 updates the display by referring to the modified source tree. Since the nodes belonging to the vocabulary of the SVG unit 60 itself is not modified, the SVG unit 60 may disregard the mutation event.

Depending on the contents in the editing, modifying the display by the HTML unit 50 may change the overall layout. In such a case, the layout of each display area for each plug-in will be updated by a component that manages the layout of a screen, for example, a plug-in which is in charge of displaying the highest node. For example, when the display area by the HTML unit 50 becomes larger than before, the HTML unit 50 first draws an area taken care of by the HTML unit 50 itself and then determines the size of the display area. Then, the size of the display area is notified to the component that manages the layout of a screen so as to request the updating of the layout. Upon receipt of this notice, the component that manages the layout of a screen lays out anew the display area for each plug-in. Accordingly, the displaying of the edited portion is appropriately updated and the overall screen layout is updated.

A functional structure to implement the document processing apparatus 20 having the prerequisite technology is detailed below.

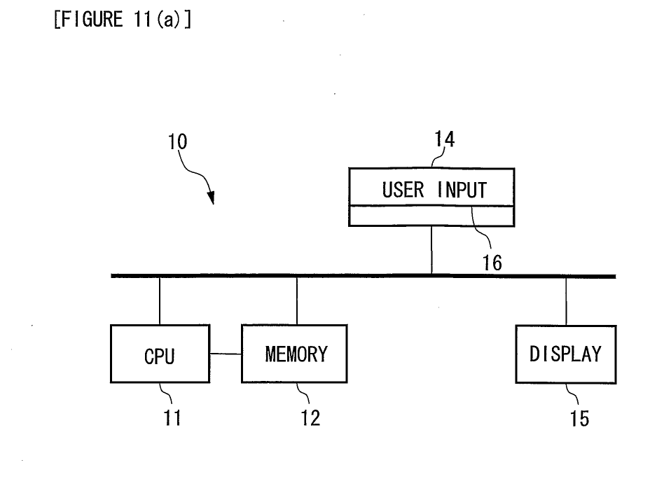

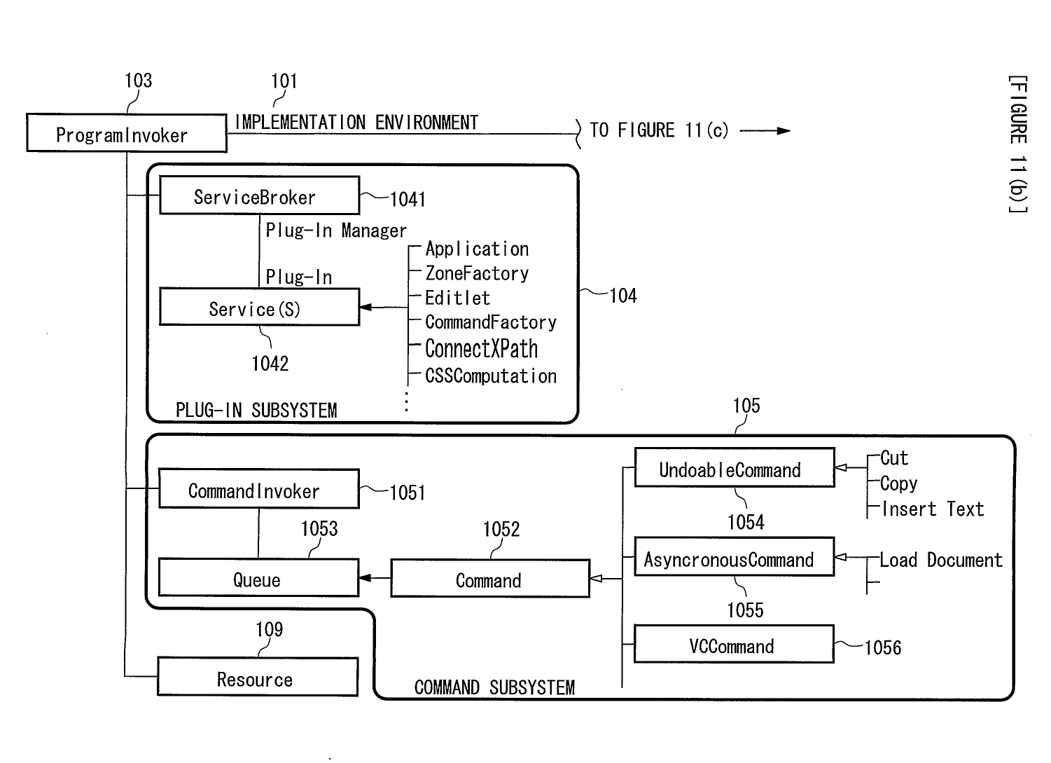

An exemplary implementation of a document processing and management system is discussed herein with reference to FIGS. 11-29.

FIG. 11(a) illustrates a conventional arrangement of components that can serve as the basis of a document processing and management system, of the type subsequently detailed herein. The arrangement 10 includes a processor, in the form of a CPU or microprocessor 11 that is coupled to a memory 12, which may be any form of ROM and/or RAM storage available currently or in the future, by a communication path 13, typically implemented as a bus. Also coupled to the bus for communication with the processor 11 and memory 12 are an I/O interface 16 to a user input 14, such as a mouse, keyboard, voice recognition system or the like, and a display 15 (or other user interface). Other devices, such as a printer, communications modem and the like may be coupled into the arrangement, as would be well known in the art. The arrangement may be in a stand alone or networked form, coupling plural terminals and one or more servers together, or otherwise distributed in any one of a variety of manners known in the art. The invention is not limited by the arrangement of these components, their centralized or distributed architecture, or the manner in which various components communicate.

Further, it should be noted that the system and the exemplary implementations discussed herein are discussed as including several components and sub-components providing various functionalities. It should be noted that these components and sub-components could be implemented using hardware alone, software alone as well as a combination of hardware and software, to provide the noted functionalities. In addition, the hardware, software and the combination thereof could be implemented using general purpose computing machines or using special hardware or a combination thereof. Therefore, the structure of a component or the sub-component includes a general/special computing machine that runs the specific software in order to provide the functionality of the component or the sub-component.

FIG. 11(b) shows an overall block diagram of an exemplary document processing and management system. Documents are created and edited in such a document processing and management system. These documents could be represented in any language having characteristics of markup languages, such as XML. Also, for convenience, terminology and titles for the specific components and sub-components have been created. However, these should not be construed to limit the scope of the general teachings of this disclosure.

The document processing and management system can be viewed as having two basic components. One component is an “implementation environment” 101, that is the environment in which the processing and management system operates. For example, the implementation environment provides basic utilities and functionalities that assist the system as well as the user in processing and managing the documents. The other component is the “application component” 102, which is made up of the applications that run in the implementation environment. These applications include the documents themselves and their various representations.

1. Implementation Environment

A key component of the implementation environment 101 is a program invoker 103. The program invoker 103 is the basic program that is accessed to start the document processing and management system. For example, when a user logs on and initiates the document processing and management system, the program invoker 103 is executed. The program invoker 103, for example and without limitation, can read and process functions that are added as plug-ins to the document processing and management system, start and run applications, and read properties related to documents. When a user wishes to launch an application that is intended to be run in the implementation environment, the program invoker 103 finds that application, launches it and then executes the application. For example, when a user wishes to edit a document (which is an application in the implementation environment) that has already been loaded onto the system, the program invoker 103 first finds the document and then executes the necessary functions for loading and editing the document.

Program invoker 103 is attached to several components, such as a plug-in subsystem 104, a command subsystem 105 and a resource module 109. These components are described subsequently in greater detail.

1. a. Plug-in Subsystem

Plug-in subsystem 104 is used as a highly flexible and efficient facility to add functions to the document processing and management system. Plug-in subsystem 104 can also be used to modify or remove functions that exist in the document processing and management system. Moreover, a wide variety of functions can be added or modified using the plug-in subsystem. For example, it may be desired to add the function “editlet,” which is operative to help in rendering documents on the screen, as previously mentioned and as subsequently detailed. The plug-in editlet also helps in editing vocabularies that are added to the system.

The plug-in subsystem 104 includes a service broker 1041. The service broker 1041 manages the plug-ins that are added to the document processing and management system, thereby brokering the services that are added to the document processing and management system.

Individual functions representing functionalities that are desired are added to the system in the form of “services” 1042. The available types of services 1042 include, but are not limited to, an application service, a zone factory service, an editlet service, a command factory service, a connect xpath service, a CSS computation service, and the like. These services and their relationship to the rest of the system are described subsequently in detail, for a better understanding of the document processing and management system.

The relation between a plug-in and a service is that plug-in is a unit that can include one or more service providers, each service provider having one or more classes of services associated with it. For example, using a single plug-in that has appropriate software applications, one or more services can be added to the system, thereby adding the corresponding functionalities to the system. Even for a given service, for example an editlet service, a capability to process a single or multiple vocabularies may be provided in a respective plug-in.

1. b. Command Subsystem

The command subsystem 105 is used to execute instructions in the form of commands that are related to the processing of documents. A user can perform operations on the documents by executing a series of instructions. For example, the user processes an XML document, and edits the XML DOM tree corresponding to the XML document in the document management system, by issuing instructions in the form of commands. These commands could be input using keystrokes, mouse clicks, or other effective user interface actions. Sometimes, more than one instruction could be executed by a command. In such a case, these instructions are wrapped into a single command and are executed in succession. For example, a user may wish to replace an incorrect word with a correct word. In such a case, a first instruction may be to find the incorrect word in the document. A second instruction may be to delete the incorrect word. A third instruction may be to type in the correct word. These three instructions may be wrapped in a single command.

In some instances, the commands may have associated functions, for example, the “undo” function that is discussed later on in detail. These functions may in turn be allocated to some base classes that are used to create objects.

A component of the command subsystem 105 is the command invoker 1051, which is operative to selectively present and execute commands. While only one command invoker is shown in FIG. 11(b), more than one command invoker could be used and more than one command could be executed simultaneously. The command invoker 1051 maintains the functions and classes needed to execute the commands. In operation, commands 1052 that are to be executed are placed in a queue 1053. The command invoker creates a command thread that executes continuously. Commands 1052 that are intended to be executed by the command invoker 1051 are executed unless there is a command already executing in the command invoker. If a command invoker is already executing a command, a new command is placed at the end of the command queue 1053. However, f or each command invoker 1051, only one command will be executed at a time. The command invoker 1051 executes a command exception if a specified command fails to be executed.

The types of commands that may be executed by the command invoker 1051 include, but are not limited to, undoable commands 1054, asynchronous commands 1055 and vocabulary connection commands 1056. Undoable commands 1054 are those commands whose effects can be reversed, if so desired by a user. Examples of undoable commands are cut, copy, insert text, etc. In operation, when a user highlights a portion of a document and applies a cut command to that portion, by using an undoable command, the cut portion can be “uncut” if necessary.

Vocabulary connection commands 1056 are located in the vocabulary connection descriptor script file. They are user-specified commands that can be defined by programmers. The commands could be a combination of more abstract commands, for example, for adding XML fragments, deleting XML fragments, setting an attribute, etc. These commands focus in particular on editing documents.

The asynchronous command 1055 is a command for loading or saving a document executed by the system and is executed asynchronously from the undoable command or VC command. The asynchronous command cannot be canceled, unlike the undoable command.

1. c. Resource

Resource 109 are objects that provide some functions to various classes. For example, string resource, icons and default key binds are some of the resources used the system.

2. Application component

The second main feature of the document processing system, the application component 102, runs in the implementation environment 101. Broadly, the application component 102 includes the actual documents, including their various logical and physical representations within the system. It also includes the components of the system that are used to manage the documents. The application component 102 further includes the user application 106, application core 108, the user interface 107 and the core component 110.

2. a. User Application

A user application 106 is loaded onto the system along with the program invoker 103. The user application 106 is the glue that holds together the documents, the various representation of the document and the user interface features that are needed to interact with a document. For example, a user may wish to create a set of documents that are part of a project. These documents are loaded, the appropriate representations for the documents are created, and the user interface functionalities are added as part of the user application 106. In other words, the user application 106, holds together the various aspects of the documents and their representation that enable the user to interact with the documents that form part of the project. Once the user application 106 is created, the user can simply load the user application 106 onto the implementation environment, every time the user wishes to interact with the documents that form part of the project.

2. b. Core component

The core component 110 provides a way of sharing documents among multiple panes. A pane, which as discussed subsequently in detail represents a DOM tree, handles the physical layout of the screen. For example, a physical screen consists of various panes within the screen that describes individual pieces of information. In fact the document, which is viewed by a user on the screen, could appear in one or more panes. In addition two different documents could appear on the screen in two different panes.

The physical layout of the screen also is in the form of a tree, as illustrated in FIG. 11(c). Thus, where a component 1083 is to be on a screen as a pane, the pane could be implemented as a root-pane 1084. Alternately, it could be a sub-pane 1085. A root pane 1084 is the pane at the root of the tree of panes and a sub-pane 1085 is any pane other than the root pane 1084.

The core component 110 also provides fonts and acts as a source of plural functional operations, e.g., a toolkit, for the documents. One example of a task performed by the core component 110 is moving the mouse cursor among the various panes. Another example of a task performed is to mark a portion of a document in one pane and copy it onto another pane containing a different document.

2. c. Application core

As noted above, the application component 102 is made up of the documents that are processed and managed by the system. This includes various logical and physical representations for the document within the system. The application core 108 is a component of the application component 102. Its functionality is to hold the actual documents with all the data therein. The application core 108 includes the document manager 1081 and the documents 1082 themselves.

Various aspects of the document manager 1081 are described subsequently herein in further detail. Document manager 1081 manages documents 1082. The document manager 1081 is also connected to the root pane 1084, sub-pane 1085, a clip-board utility 1086 and a snapshot utility 1087. The clip-board utility 1086 provides a way of holding a portion of a document that a user decides to add to a clip-board. For example, a user may wish to cut a portion of the document and save it onto a new document for reviewing later on. In such a case, the cut portion is added to the clip-board 1086.

The snapshot utility 1087 is also described subsequently, and enables a current state of the application to be memorized as the application moves from one state to another state.

2. d. User Interface

Another component of the application 102 is the user interface 107 that provides a means for the user to physically interact with the system. For example, the user interface, as implemented in physical interface 1070, is used to by the user to upload, delete, edit and manage documents. The user interface 107 includes frame 1071, menu bar 1072, status bar 1073 and the URL bar 1074.

A frame, as is typically known, can be considered to be an active area of a display, e.g., a physical screen. The menu bar 1072 is an area of the screen that includes a menu presenting choices for the user. The status bar 1073 is an area of the screen that displays the status of the execution of the application. The URL bar 1074 provides an area for entering a URL address for navigating the Internet.

3. Document Manager and the Associated Data Structures

FIG. 12 shows further details on the document manager 1081. This includes the data structures and components that are used to represent documents within the document processing and management system. For a better understanding, the components described in this subsection are described using the model view controller (MVC) representation paradigm.

The document manager 1081 includes a document container 203 that holds and hosts all of the documents that are in the document processing and management system. A toolkit 201, which is attached to the document manager 1081, provides various tools for the use by the document manager 1081. For example, “DOM service” is a tool provided by the toolkit 201 that provides all the functionalities needed to create, maintain and manage a DOM corresponding to a document. “IO manager,” which is another tool provided by the toolkit 201, manages the input and output, to and from the system, respectively. Likewise “stream handler” is a tool that handles the uploading of a document by means of a bit stream. These tools are not specifically illustrated or assigned reference numbers in the Figures, but form a component of the toolkit 201.

According to the MVC paradigm representation, the model (M) includes a DOM tree model 202 for a document. As discussed previously, all documents are represented within the document processing and management system as DOM trees. The document also forms part of the document container 203.

3. a. DOM Model and Zone

The DOM tree that represents a document is a tree having nodes 2021. A zone 209, which is a subset of the DOM tree, includes one or more nodes of interest within the DOM tree. For example, only a part of a document may be presented on a screen. This part of the document that is visible could be represented using a “zone” 209. Zones are created, handled and processed using a plug-in called “zone factory” 205. While a zone represents a part of a DOM, it could use more than one “namespace.” As is well-known in the art, a namespace is a collection or a set of names that are unique within the namespace. In other words, no two names within the namespace can be the same.

3. b. Facet and its Relationship with Zone

“Facet” 2022 is another -component within the Model (M) part of the MVC paradigm. It is used to edit nodes in a zone. Facet 2022 organizes the access to a DOM, using procedures that can be executed without affecting the contents of the zone itself. As subsequently explained, these procedures perform meaningful and useful operations related to the nodes.

Each node 2021 has a corresponding facet 2022. By using facets to perform operations, instead of operating directly on the nodes in a DOM, the integrity of the DOM is preserved. Otherwise, if operations are per-formed directly on the node, several plug-ins could make changes to the DOM at the same time, causing inconsistency.

The DOM standard formed by W3C defines a standard interface for operating on nodes, although a specific operation is provided- on a per-vocabulary or per-node basis, and these operations are preferably provided as an API. The document processing/management system provides such a node-specific API as a facet and attaches the facet to each node. This adds a useful API while conforming to the DOM standard. By adding a specific API after a standard DOM has been implemented, rather than implementing a specific DOM to each vocabulary, it is possible to centrally process a variety of vocabularies and properly process a document in which an arbitrary combination of vocabularies is present.

As previously defined, a “vocabulary” is a set of tags, for example XML tags, belonging to a namespace. As noted above, a namespace has a unique set of names (or tags in this specific case). A vocabulary appears as a subtree of a DOM tree representing an XML document. Such a sub-tree comprises a zone. In a specific example, boundaries of the tag sets are defined by zones. A zone 209 is created using service called a “zone factory service” 205. As described above, a zone 209 is an internal representation of only a part of a DOM tree that represents a document. To provide access to such a part of the document, a logical representation is required. Such a logical representation informs the computer as to how the document is logically presented on a screen. As previously defined, a “canvas,” such as canvas 210, is a service that is operative to provide a logical layout corresponding to a zone.

A “pane”, such as pane 211, on the other hand, is the physical screen layout corresponding to the logical layout provided by the canvas 210. In effect, the user sees only a rendering of the document on a display screen in terms of characters and pictures. Therefore, the document must be rendered on the screen by a process for drawing characters and pictures on the screen. Based on the physical layout provided by the pane 211, the document is rendered on the screen by the canvas 210.

The canvas 210, which corresponds to the zone 209, is created using the “editlet service” 206. A DOM of a document is edited using the editlet service 206 and canvas 210. In order to maintain integrity of the original document, the editlet service 206 and the canvas service 210 use facets 2022 corresponding to the one or more nodes in the zone 209. These services do not manipulate nodes in the zone and the DOMs directly. The facet is manipulated using commands 207 from the (C)-component of the MVC paradigm, the controller.

A user typically interacts with the screen, for example, by moving cursor on the screen, and/or by typing commands. The canvas 2010, which provides the logical layout of the screen, receives these cursor manipulations. The canvas 2010 then enables corresponding action to be taken on the facets. Given this relationship, the cursor subsystem 204 serves as the Controller (C) of the MVC paradigm for the document manager 1081.

The canvas 2010 also has the task of handling events. For example, the canvas 2010 handles events such as mouse clicks, focus moves, and similar user initiated actions.

3. c. Summary of Relationships Between Zone, Facet, Canvas and Pane

A document within the document management and processing system can be viewed from at least four perspectives, namely: 1) data structure that is used to hold the contents and structure of the document in the document management system, 2) means to edit the contents of the document without affecting the integrity of the document; 3) a logical layout of the document on a screen; and, 4) a physical layout of the document on the screen. Zone, facet, canvas and pane represent components of the document management system that correspond to the above-mentioned four perspectives, respectively.

3. d. Undo Subsystem

As mentioned above, it is desirable that any changes to documents (for example, edits) should be undoable. For example, a user may perform an edit operation and then decide to undo such a change. With reference to FIG. 12, the undo subsystem 212 implements the undoable component of the document manager. An undo manager 2121 holds all of the operations on a document that have a possibility of being undone by the user.

For example, a user may execute a command to replace a word in a document with another word. The user may then change his mind and decide to retain the original word. The undo subsystem 212 assists in such an operation using an undoable edit 2122. The undo manager 2121 holds such an undoable edit 2122 operation. The operation may extend beyond a single XML operation type, and may involve sequentially changing features of a document in a variety of languages, such as XHTML, SVG and MathML, and then undoing the changes in each of those languages. Thus, in a first in-last out operation, the most recent changes are cancelled first, regardless of vocabulary used, and then the next most recent change, etc. is cancelled. Thus, even if two or more editlets are edited, a united undo can be performed in correct order, giving a feeling of a natural and logical operation.

3. e. Cursor Subsystem

As previously noted, the controller part of the MVC can comprise the cursor subsystem 204. The cursor subsystem 204 receives inputs from the user. These inputs typically are in the nature of commands and/or edit operations. Therefore, the cursor subsystem 204 can be considered to be the controller (C) part of the MVC paradigm relating to the document manager 1081.

3. f. View

As noted previously, the canvas 2010 represents the logical layout of the document that is to be presented on the screen. For a specific example of an XHTML document, the canvas may include a box tree 208, which is the logical representation of how the document is viewed on the screen. Such a box tree 208 would be included in the view (V) part of the MVC paradigm relating to the document manager 1081.

4. Vocabulary Connection

A significant feature of the document processing management system is that a document can be represented and displayed in two different ways (for example, in two markup languages), such that consistency is maintained automatically between the two different representations.

A document in a markup language, for example in XML is created on the basis of a vocabulary that is defined by a document type definition. Vocabulary is in turn a set of tags. The vocabulary may be defined arbitrarily. This raises the possibility of having an infinite number of vocabularies. But then, it is impractical to provide separate processing and management environments that are exclusive for each of the multitude of possible vocabularies. Vocabulary connection provides a way of overcoming this problem.

For example, documents could be represented in two or more markup languages. The documents could, for example, be in XHTML (eXtensibel HyperText Markup Language), SVG (Scalable Vector Graphics), MathML (Mathematical Markup Language), or other mark up languages. In other words, a markup language could be considered to be the same as a vocabulary and tag set in XML.

A vocabulary is implemented using a vocabulary plug-in. A document described in a vocabulary, whose plug-in is not available within the document processing and management system, is displayed by mapping the document to another vocabulary whose plug-in is available. Because of this feature, a document in a vocabulary, which is not plugged-in, could still be properly displayed.

Vocabulary connection includes capabilities for acquiring definition files, mapping between definition files (as defined subsequently) and for generating definition files. A document described in a certain vocabulary can be mapped to another vocabulary. Thus, vocabulary connection provides the capability to display or edit a document by a display and editing plug-in corresponding to the vocabulary to which the document has been mapped.

As noted, each document is described within the document processing and management system as a DOM tree, typically having a plurality of nodes. A “definition file” describes for each node the connections between such node and other nodes. Whether the element values and attribute values of each node are editable is specified. Operation expressions using the element values or attribute values of nodes may also be described.

By use of a mapping feature, a destination DOM tree is created that refers to the definition file. Thus, a relationship between a source DOM tree and a destination DOM tree is established and maintained. Vocabulary connection monitors the connection between a source DOM tree and a destination DOM tree. On receiving an editing instruction from a user, vocabulary connection modifies a relevant node of the source DOM tree. As previously noted, a “mutation event,”which indicates that the source DOM tree has been modified, is issued and the destination DOM tree is modified accordingly.

By using vocabulary connection, a relatively minor vocabulary known to only a small number of users can be converted into another major vocabulary. Thus, a document can be displayed properly and a desirable editing environment can be provided, even with respect to a minor vocabulary that is utilized by a small number of users.

Thus, a vocabulary connection subsystem that is part of the document management system provides the functionality for making a multiple representation of the documents possible.

FIG. 13 shows the vocabulary connection (VC) subsystem 300. The VC system 300 provides a way of maintaining consistency between two alternate representations of the same document. In the Figure, the same components, as previously illustrated and identified, appear and are interconnected to achieve that purpose. For example, the two representations could be alternate representations of the same document in two different vocabularies. As previously explained, one could be a source DOM tree and the other could be a destination DOM tree.

4. a. Vocabulary Connection Subsystem

The function of the vocabulary connection subsystem 300 is implemented in the document processing and management system using a plug-in called a “vocabulary connection” 301. For each vocabulary 305 in which a document is to be represented, a corresponding plug-in is required. For example, if a part of a document is represented in HTML and the rest in SVG, corresponding vocabulary plug-ins for HTML and SVG are required.

The vocabulary connection plug-in 301 creates the appropriate vocabulary connection canvases 310 for a zone 209 or a pane 211, which correspond to a document in the appropriate vocabulary 305. Using vocabulary connection 301, changes to a zone 209 in a source DOM tree is transferred to a corresponding zone in another DOM tree 306 using conversion rules. The conversion rules are written in the form of vocabulary connection descriptors (VCD). For each VCD file that corresponds to one such transfer between a source and a destination DOM, a corresponding vocabulary connection manager 302 is created.

4. b. Connector

A connector 304 connects a source node in source DOM tree and a destination node in a destination DOM tree. Connector 304 is operative to view the source node in the source DOM tree and the modifications (mutations) to the source document that correspond to the source node. It then modifies the nodes in the corresponding destination DOM tree. Connectors 304 are the only objects that can modify the destination DOM tree. For example, if a user can make modifications only to the source document and the corresponding source DOM tree, the connectors 304 then make the corresponding modifications in the destination DOM tree.

Connectors 304 are linked together Logically to form a tree structure, as illustrated in FIG. 13. The tree formed by connectors 304 is called a “connector tree.” Connectors 304 are created using a service called the “connector factory” 303 service. The connector factory 303 creates connectors 304 from the source document and links them together in the form of a connector tree. The vocabulary connection manager 302 maintains the connector factory 303.

As discussed previously, a vocabulary is a set of tags in a namespace. As illustrated in FIG. 13, a vocabulary 305 is created for a document by the vocabulary connection 301. This is done by parsing the document file and creating an appropriate vocabulary connection manager 302 for the transfer between the source DOM and destination DOM. In addition, appropriate associations are made between the connector factory 303 that creates the connectors, the zone factory service 205 that creates the zones 209, and the editlet service 206 that create canvases corresponding to the nodes in the zones. When a user disposes of or deletes a document from the system, the corresponding vocabulary connection manager 302 is deleted.

Vocabulary 305 in turn creates the vocabulary connection canvas 310. In addition, connectors 304 and the destination DOM tree 306 are correspondingly created.

It should be understood that the source DOM and canvas correspond to a model (M) and view (V), respectively. However, such a representation is meaningful only when a target vocabulary can be rendered on the screen. Such a rendering is done by vocabulary plug-ins. Vocabulary plug-ins are provided for major vocabularies, for example XHTML, SVG and MathML. The vocabulary plug-ins are used in relation to target vocabularies. They provide a way for mapping among vocabularies using the vocabulary connection descriptors.

Such a mapping makes sense only in the context of a target vocabulary that is mappable and has a pre-defined way of being rendered on the screen. Such ways of rendering are industry standards, for example XHTML, which are defined by organizations such as W3C.

When there is a need for a vocabulary connection, a vocabulary connection canvas is used. In such cases, the source canvas is not created, as the view for the source cannot be created directly. In such a case a vocabulary connection canvas is created using a connector tree. Such a vocabulary connection canvas handles only event conversion and does not assist in the rendering of a document on the screen.

4. c. Destination Zones; Panes and Canvases

As noted above, the purpose of the vocabulary connection subsystem is to create and maintain concurrently two alternate representations for the same document. The second alternate representation also is in the form of a DOM tree, which previously has been introduced as a destination DOM tree. For viewing the document in the second representation, destination zones, canvases and panes are required.

Once the vocabulary connection canvas is created, corresponding destination panes 307 are created, as illustrated in FIG. 13. In addition, the associated destination canvas 308 and the corresponding box tree 309 are created. Likewise, the vocabulary connection canvas is also associated with the pane 211 and zone 209 for the source document.

Destination canvas 308 provides the logical layout of the document in the second representation. Specifically, destination canvas 308 provides user interface functions, such as cursor and selection, for rendering the document in the destination representation. Events that occurred on the destination canvas 308 are provided to the connector. Destination canvas 308 notifies mouse events, keyboard events, drag and drop events and events original to the vocabulary of the destination (or the second) representation of the document to the connectors 304.

4. d. Vocabulary Connection Command Subsystem

An element of the vocabulary connection subsystem 300 of FIG. 13 is the vocabulary connection command subsystem 313. Vocabulary connection command subsystem 313 creates vocabulary connection commands 315 that are used for implementing instructions related to the vocabulary connection subsystem 300. Vocabulary connection commands can be created using built-in command templates 3131 and/or by creating the commands from scratch using a scripting language in a scripting system 314.

Examples of command templates include an “If” command template, a “When” command template, an “Insert fragment” command template, and the like. These templates are used to create vocabulary connection commands.

4. e. Xpath Subsystem

Xpath subsystem 316 is an important component of the document processing and managing system in that it assists in implementing vocabulary connection. The connectors 304 typically include xpath information. As noted above, a task of the vocabulary connection is to reflect changes in the source DOM tree onto the destination DOM tree. The xpath information includes one or more xpath expressions that are used to determine the subsets of the source DOM tree that need to be watched for changes/modifications.

4. f. Summary of Source DOM Tree, Destination DOM Tree and the Connector Tree

The source DOM tree is a DOM tree or a zone that represents a document in a vocabulary prior to conversion to another vocabulary. The nodes in the source DOM tree are referred to as source nodes.

The destination DOM tree, on the other hand represents a DOM tree or a zone for the same document in a different vocabulary after conversion using the mapping, as described previously in relation to vocabulary connection. The nodes in the destination DOM tree are called destination nodes.

The connector tree is a hierarchical representation that is based on connectors, which represent connections between a source node and a destination node. Connectors view the source nodes and the modifications made to the source document. They then modify the destination DOM tree. In fact, connectors are the only objects that are allowed to modify the destination DOM trees.

5. Event Flow in the Document Processing and Management System

In order to be useful, programs must respond to commands from the user. Events are a way to describe and implement user actions performed on program. Many higher level languages, for example Java, rely on events that describe user actions. Conventionally, a program had to actively collect information for understanding a user action and implementing it by itself. This could, for example, mean that, after a program initialized itself, it entered a loop in which it repeatedly looked to see if the user performed any actions on the screen, keyboard, mouse, etc, and then took the appropriate action. However, this process tends be unwieldy. In addition, it requires a program to be in a loop, consuming CPU cycles, while waiting for the user to do something.

Many languages solve these problems by embracing a different paradigm, one that underlies all modern window systems: event-driven programming. In this paradigm, all user actions belong to an abstract set of things called “events.” An event describes, in sufficient detail, a particular user action. Rather than the program actively collecting user-generated events, the system notifies the program when an interesting event occurs. Programs that handle user interaction in this fashion are said to be “event driven.”

This is often handled using an Event class, which captures the fundamental characteristics of all user-generated events.

The document processing and management system defines and uses its own events and the way in which these events are handled. Several types of events are used. For example, a mouse event is an event originating from a user's mouse action. User actions involving the mouse are passed on to the mouse event by the canvas 210. Thus, the canvas can be considered to be at the forefront of interactions by a user with the system. As necessary, a canvas at the fore front will pass its event-related content on to its children.

A keystroke event, on the other hand, flows from the canvas 210. The key stroke event has an instant focus, that is, it relates to activity at any instant. The keystroke event entered onto the canvas 210 is then are passed on to its parents. Key inputs are processed by a different event that is capable of handling string inserts. The event that handles string inserts is triggered when characters are inserted using the keyboard. Other “events” include, for example, drag events, drop events, and other events that are handled in a manner similar to mouse events.

5. a. Handling of Events Outside Vocabulary Connection

The events are passed using event threads. On receiving the events, canvas 210 changes its state. If required, commands 1052 are posted to the command queue 1053 by the canvas 210.

5. b. Handling of Event Within Vocabulary Connection

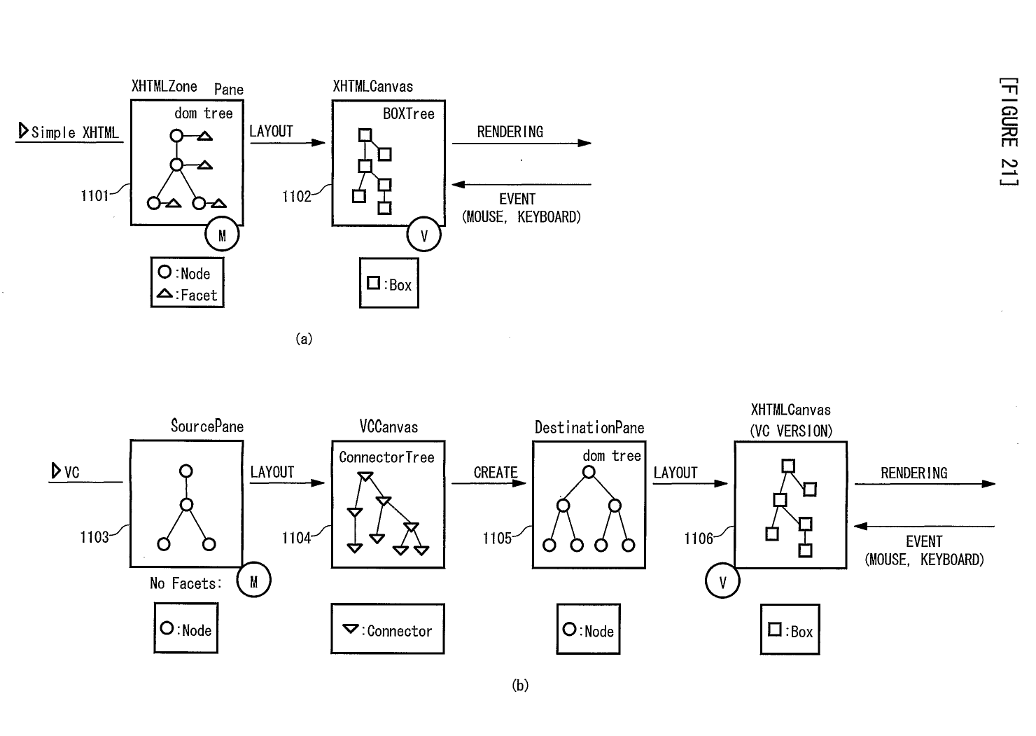

With the use of the vocabulary connection plug-in 301, the destination canvas 1106 receives the existing events, like mouse events, keyboard events, drag and drop events and events original to the vocabulary. These events are then notified to the connector 1104. More specifically, the event flow within the vocabulary connection plug in 301 goes through source pane 1103, vocabulary canvas 1104, destination pane 1105, destination canvas 1106, destination DOM tree and the connector tree 1104, as illustrated in FIG. 21.

6. Program Invoker and its Relation with other Components

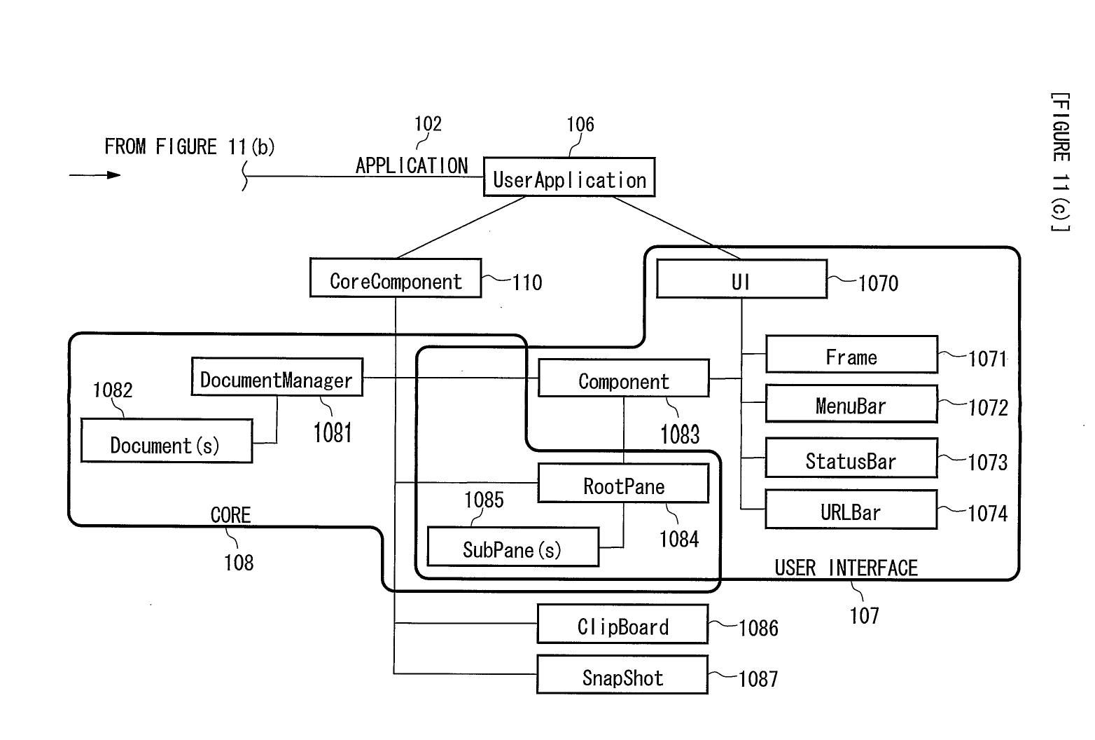

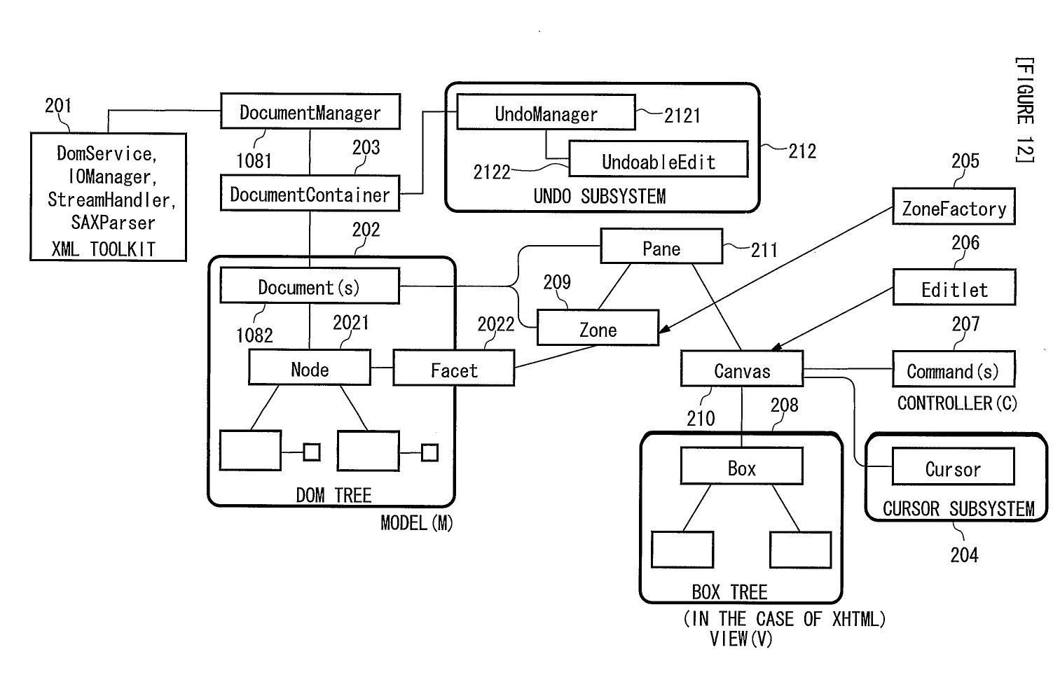

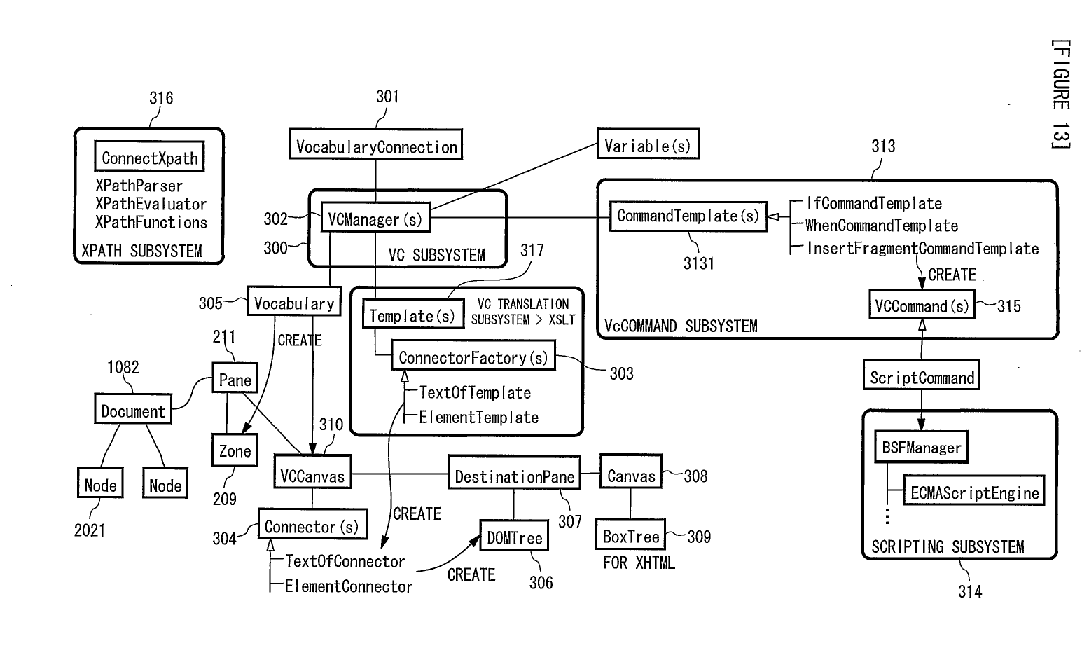

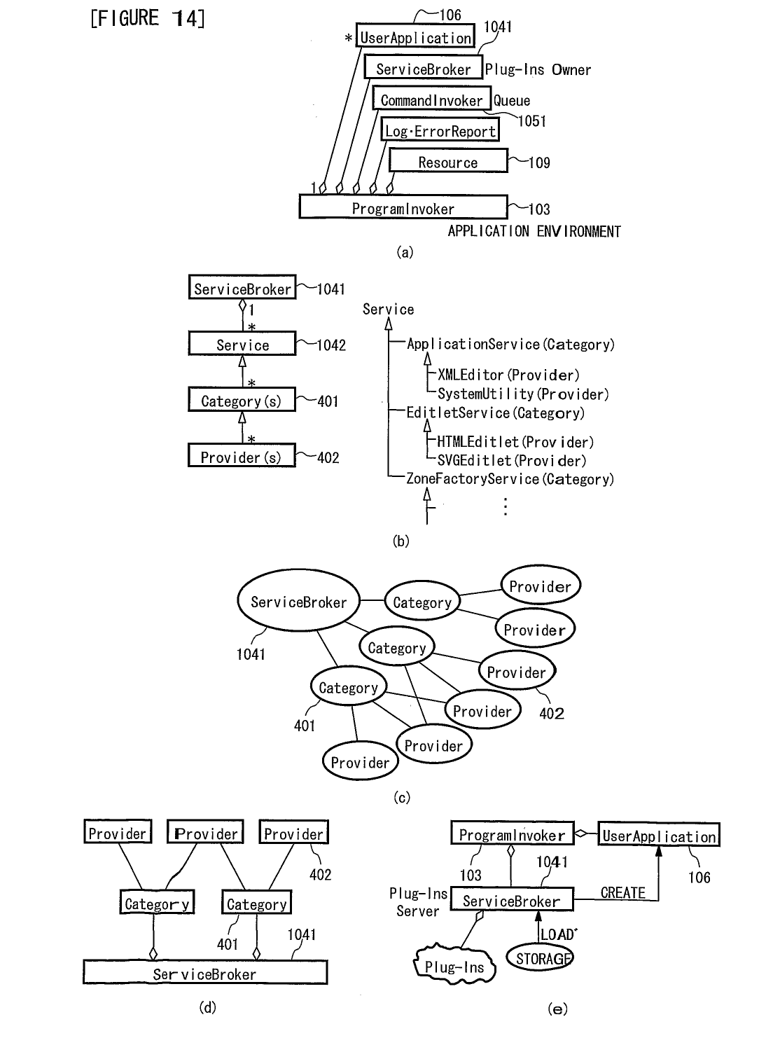

The program invoker 103 and its relation with other components is shown in FIG. 14(a) in further detail. Program invoker 103 is the basic program in the implementation environment that is executed to start the document processing and management system. The user application 106, service broker 104, the command invoker 1051 and the resource 109 are all attached to the program invoker 103, as illustrated in FIG. 14(b). As noted previously, the application 102 is the component that runs in the implementation environment. Likewise, the service broker 104 manages the plug-ins that add various functions to the system. The command invoker 1051 on the other hand, maintains the classes and functions that are used to execute commands, thereby implementing the instructions provided by a user.

6. a. Plug-ins and Service

The service broker 104 is discussed in further detail with reference to FIG. 14(b). As noted earlier, the service broker 104 manages the plug-ins (and the associated services) that add various functions to the system. A service 1041 is the lowest level at which features can be added to (or changed within) the document processing and management system. A “service” consists of two parts; a service category 401 and a service provider 402. As illustrated in FIG. 14(c), a single service category 401 can have multiple associated service providers 402, each of which is operative to implement all or a portion of a particular service category. Service category 401, on the other hand, defines a type of service.

Services can be divided into three types: 1) a feature service, which provides a particular feature to the system, 2) an application service, which is an application to be run by the document processing and management system, and 3) an environment service, which provides features that are needed throughout the document processing and management system.

Examples of services are shown in FIG. 14(d). Under the category of application service, system utility is an example of the corresponding service provider. Likewise editlet 206 is a category and HTML editlet and SVG editlets are the corresponding service providers. Zone factory 205 is another category of service and has corresponding service providers, not illustrated.

The plug-in that was previously described as adding functionality to the document processing and management system, may be viewed as a unit that consists of several service providers 402 and the classes relating to them, as illustrated in FIG. 14(c) and (d). Each plug-in would have its dependencies and service categories 401 written in a manifest file.

6. b. Relation Between Program Invoker and the Application

FIG. 14(e) shows further details on the relationships between the program invoker 103 and the user application 106. The required documents, data, etc are loaded from storage. All the required plug-ins are loaded onto the service broker 104. The service broker 104 is responsible for and maintains all plug-ins. Plug-ins can be physically added to the system, or its functionality can be loaded from a storage. Once the content of a plug-in is loaded, the service broker 104 defines the corresponding plug-in. A corresponding user application 106 is created that then gets loaded onto the implementation environment 101 and gets attached to the program invoker 103.

7. Relation Between Application Service and the Environment

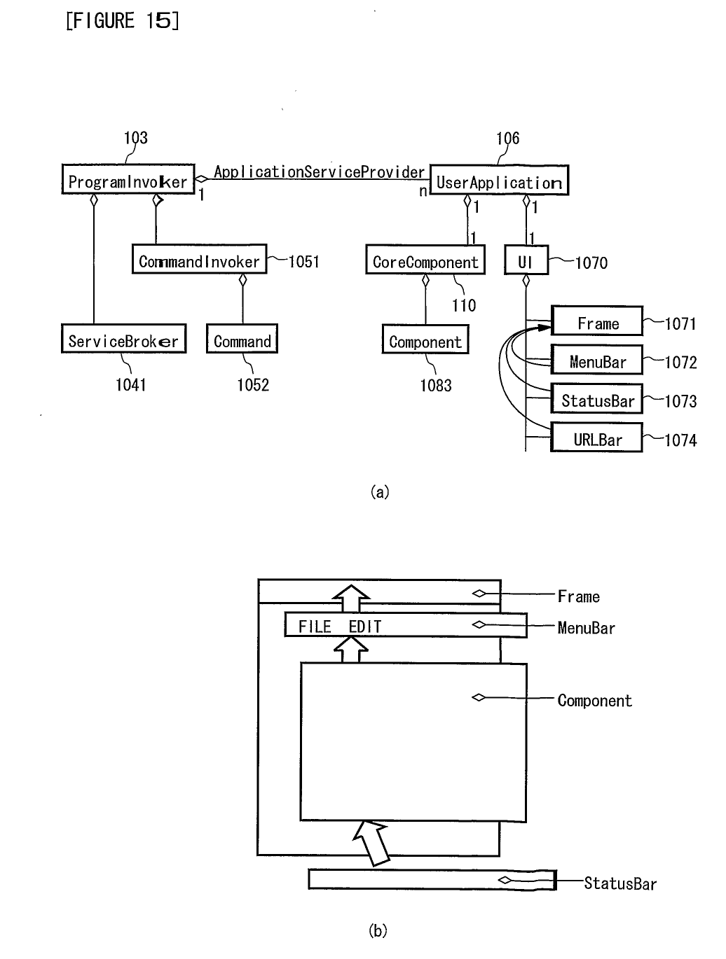

FIG. 15(a) provides further details on the structure of an application service loaded onto the program invoker 103. A command invoker 1051, which is a component of the command subsystem 105, invokes or executes commands 1052 within the program invoker 103. Commands 1052 in turn are instructions that are used for processing documents, for example in XML, and editing the corresponding XML DOM tree, in the document processing and management system. The command invoker 1051 maintains the functions and classes needed to execute the commands 1052.

The service broker 1041 also executes within the program invoker 103. The user application 106 in turn is connected to the user interface 107 and the core component 110. The core component 110 provides a way of sharing documents among all the panes. The core component 110 also provides fonts and acts as a toolkit for the panes.

FIGS. 15(a) and(b) show the relationships between a frame 1071, a menu bar 1072 and a status bar 1073.

8. Application Core

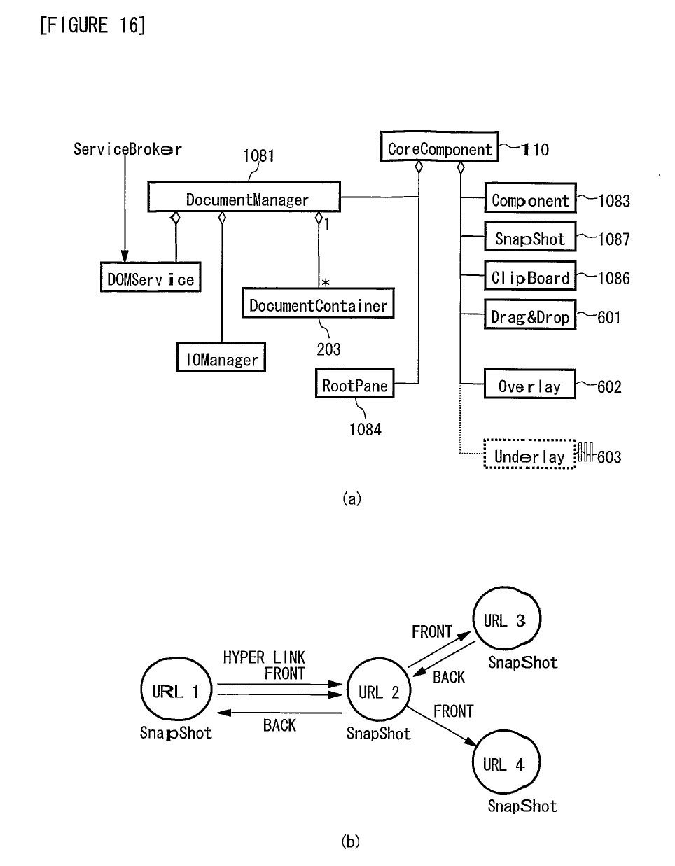

FIG. 16(a) provides additional explanations for the application core 110 that holds all the documents and the data that are part of and belong to the documents. The core component 110 is attached to the document manager 1081 that manages the documents 1082. Document manager 1081 is the proprietor of all the documents 1082 that are stored in the memory associated with the document processing and management system.

To facilitate the display of the documents on the screen, the document manager 1081 is also connected to the root pane 1084. Clip-board 1085, snapshot 1087, drag & drop 601 and overlay 602 functionalities are also attached to the core component 110.

Snap shot 1087, as illustrated in F1. 16(b), is used to undo an application state. When a user invokes the snap shot function 1087, the current state of the application is detected and stored. The content of the stored state is then saved when the state of the application changes to another state. Snap shot is illustrated in FIG. 16(b). In operation, as the application moves from one URL to the other, snapshot memorizes the previous state so that back and forward operations can be seamlessly performed.

9. Organization of Documents within the Document Manager

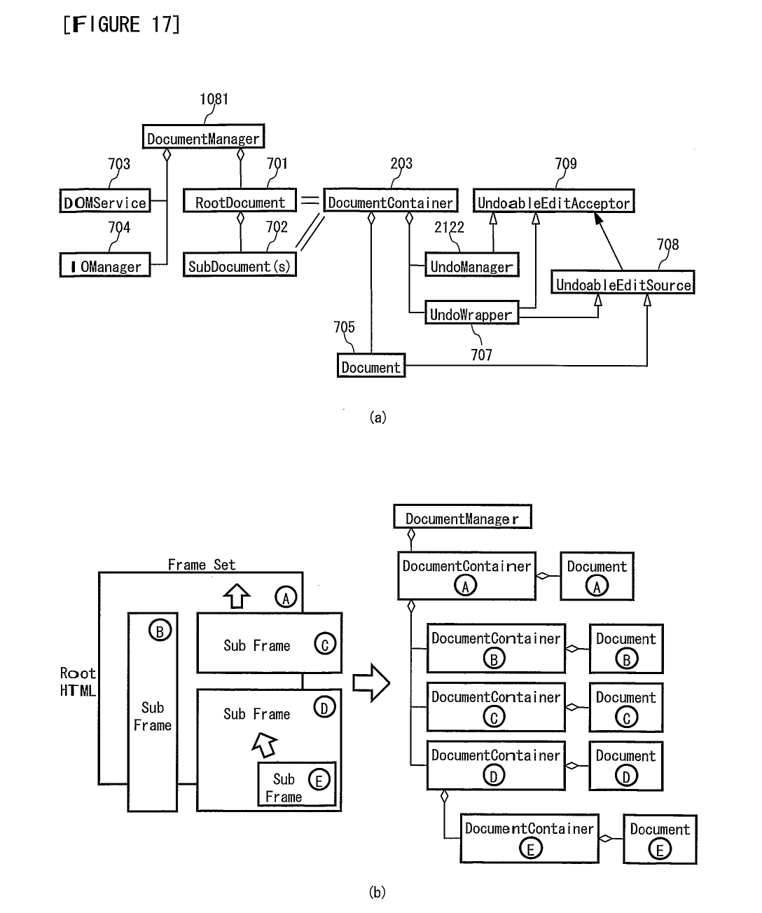

FIG. 17(a) provides further explanation for the document manager 1081 and how documents are organized and held in the document manager. As illustrated in FIG. 17(b), the document manager 1081 manages documents 1082. In the example shown in FIG. 17(a), one of the plurality of documents is a root document 701 and the remaining documents are subdocuments 702. The document manager 1081 is connected to the root document 701, which in turn is connected to all the sub-documents 702.

As illustrated in FIGS. 12 and 17(a), the document manager 1081 is coupled to the document container 203, which is an object that hosts all the documents 1082. The tools that form part of the toolkit 201(for example XML toolkit), including DOM service 703 and the IO manager 704, are also provided to the document manager 1081. Again with reference to FIG. 17(a), the DOM service 703 creates DOM trees based on the documents that are managed by the document manager 1081. Each document 705, whether it is the root document 701 or a subdocument 702, is hosted by a corresponding document container 203.

FIG. 17(b) shows an example of how a set of documents A-E is arranged in a hierarchy. Document A is a root document. Documents B-D are sub documents of document A. Document E in turn is a subdocument of document D. FIG. 17(b) also shows an example of how the same hierarchy of documents appears on a screen. The document A being a root document appears as a basic frame. Documents B-D, being sub documents of document A, appear-as sub frames within the base frame A. Document E, being a sub document of document D, appears on the screen as a sub frame of the sub frame D.

Again with reference to FIG. 17(a), an undo manager 706 and an undo wrapper 707 are created for each document container 203. The undo manager 706 and the undo wrapper 707 are used to implement the undoable command. Using this feature, changes made to a document using an edit operation can be undone. A change in a sub-document has implications with respect to the root document as well. The undo operation takes into account the changes affecting other documents within the hierarchy and ensures that consistency is maintained among all the documents in the chain of hierarchy, as illustrated in FIG. 17(b), for example.

The undo wrapper 707 wraps undo objects that relate to the sub-documents in container 203 and couples them with undo objects that relate to the root document. Undo wrapper 707 makes the collection of undo objects available to the undoable edit acceptor 709.

The undo manager 706 and the undo wrapper 707 are connected to the undoable edit acceptor 708 and undoable edit source 708. As would be understood by one skilled in the art, the document 705 may be the undoable edit source 708, and thus a source of undoable edit objects. 10. Undo command and undo framework

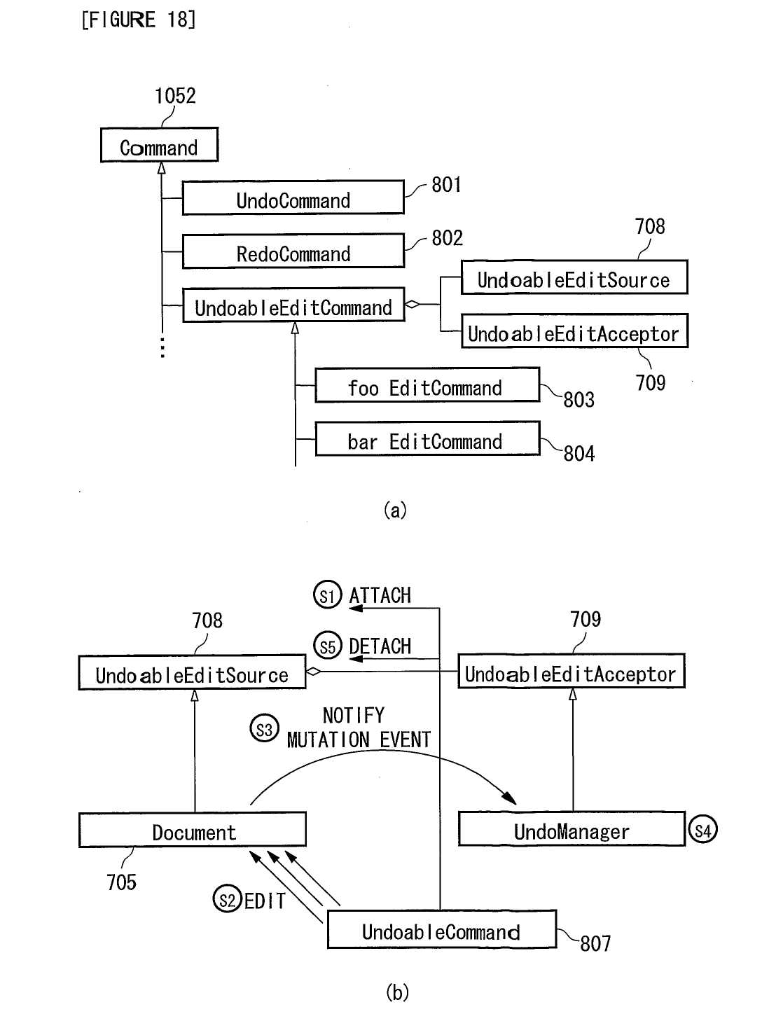

FIGS. 18(a) and 18(b) provide further details on the undo framework and the undo command. As shown in FIG. 18(a), undo command 801, redo command 802, and undoable edit command 803 are commands that can be queued in the command invoker 1051, as illustrated in FIG. 11(b), and executed accordingly. The undoable edit command 803 is further attached to undoable edit source 708 and undoable edit acceptor 709. Examples of undoable edit commands are a “foo” edit command 803 and “bar” edit command 804.

FIG. 18(b) shows the execution of an undoable edit command. First, it is assumed that a user edits a document 705 using an edit command. In the first step S1, the undoable edit acceptor 709 is attached to the undoable edit source 708, which is a DOM tree for the document 705. In the second step S2, based on the command that was issued by the user, the document 705 is edited using DOM APIs. In the third step S3, a mutation event listener is notified that a change has been made. That is, in this step a listener that monitors all the changes in the DOM tree detects the edit operation. In the fourth step S4, the undoable edit is stored as an object with the undo manager 706. In the fifth step S5, the undoable edit acceptor 709 is detached from the source 708, which may be the document 705 itself.

11. Steps Involved in Loading a Document to the System

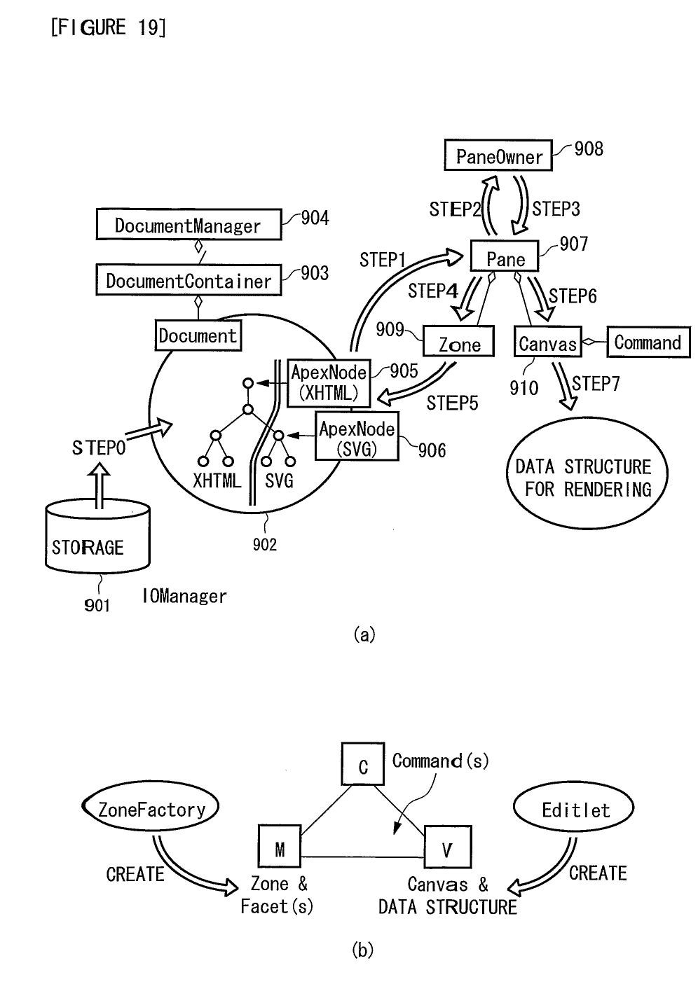

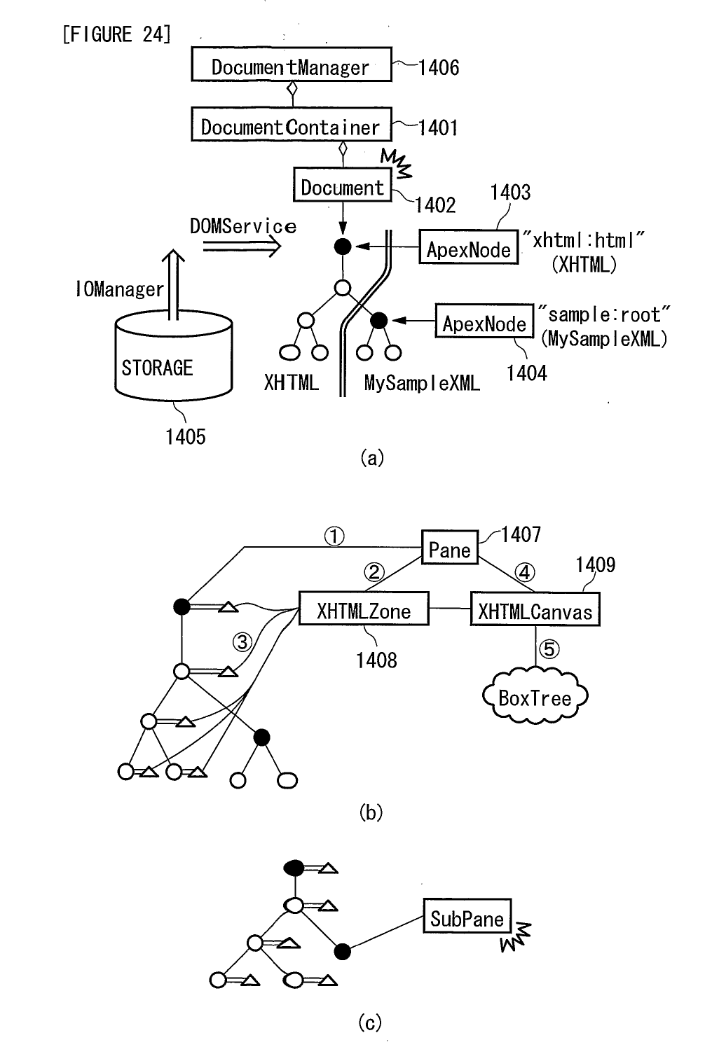

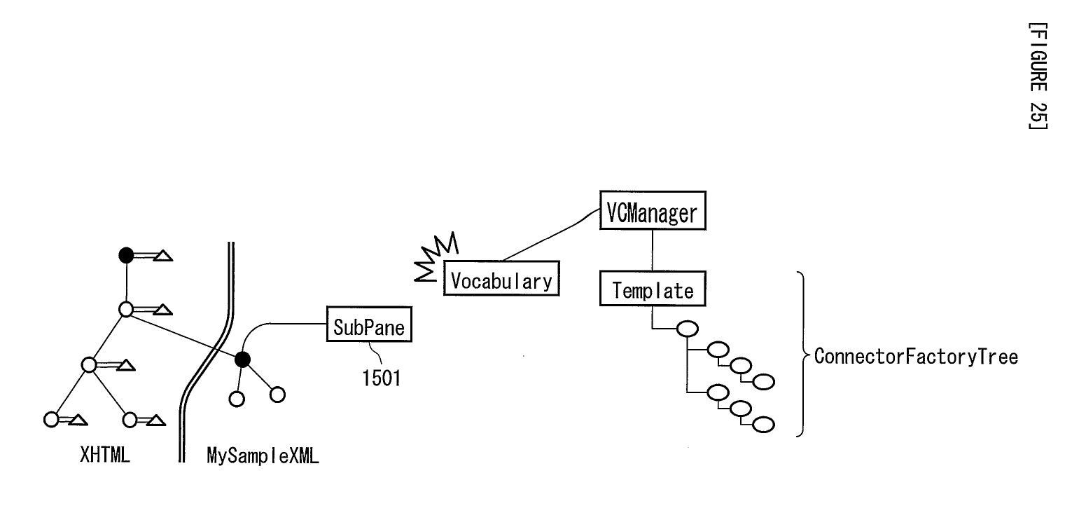

The previous subsections describe the various components and subcomponents of the system. The methodology involved in using these components is described hereunder. FIG. 19 shows an overview of how a document is loaded in the document processing and management system. Each of the steps are explained in greater detail with reference to a specific example in FIGS. 24-28.

In brief, the document processing and management system creates a DOM tree from a binary data stream consisting of the data contained in the document. An apex node is created for a part of the document that is of interest and resides in a “zone”, and a corresponding “pane” is then identified. The identified pane creates “zone” and “canvas” from the apex node and the physical screen surface. The “zone” in turn create “facets” for each of the nodes and provides the needed information to them. The canvas creates data structures for rendering the nodes from the DOM tree.

Specifically, with reference to FIG. 19(a), a compound document representing both SHTML and SVG content is loaded from storage 901 in a “step 0.” A DOM tree 902 for the document is created. Note that the DOM tree has an apex node 905(XHTML) and that, as the tree descends to other branches, a boundary is encountered as designated by a double line, followed by an apex node 906 for a different vocabulary, SVG. This representation of the compound document is useful in understanding the manner in which the document is represented and ultimately rendered for display.

Next, a corresponding document container 903 is created that holds the document. The document container 903 is then attached to the document manager 904. The DOM tree includes a root node and, optionally, a plurality of secondary nodes.

Typically such a document includes has both text and graphics. Therefore, the DOM tree, for example, could have an XHTML sub tree as well as an SVG sub tree. The XHTML sub tree has an XHTML apex node 905. Likewise the SVG sub tree has an SVG apex node 906.

Again, with reference to FIG. 19(a), in step 1, the apex node is attached to a pane 907, which is the physical layout for the screen. In step 2, the pane 907 requests the application core 908 for a zone factory for the apex node. In step 3, the application core 908 returns a zone factory and an editlet, which is a canvas factory for the apex node 906.

In step 4, the pane 907 creates a zone 909, which is attached to the pane. In step 5, the zone 909 in turn creates a facet for each node and attaches to the corresponding node. In step 6, the pane creates a canvas 910, which is attached to the pane. Various commands are include in the canvas 910. The canvas 910 in turn constructs data structures for rendering the document to the screen in step 7. In case of XHTML, this includes the box tree structure.

FIG. 19(b) shows a summary of the structure for the zone, using the MVC paradigm. The model (M) in this case includes the zone and the facets that are created by the zone factory, since these are the inputs related to a document. The view (V) corresponds to the canvas and the data structure for rendering the document on the screen using editlets, since these renderings are the outputs that a user sees on the screen. The control (C) includes the commands that are included in the canvas, since the commands perform the control operation on the document and its various relationships.

12. Representation for a Document

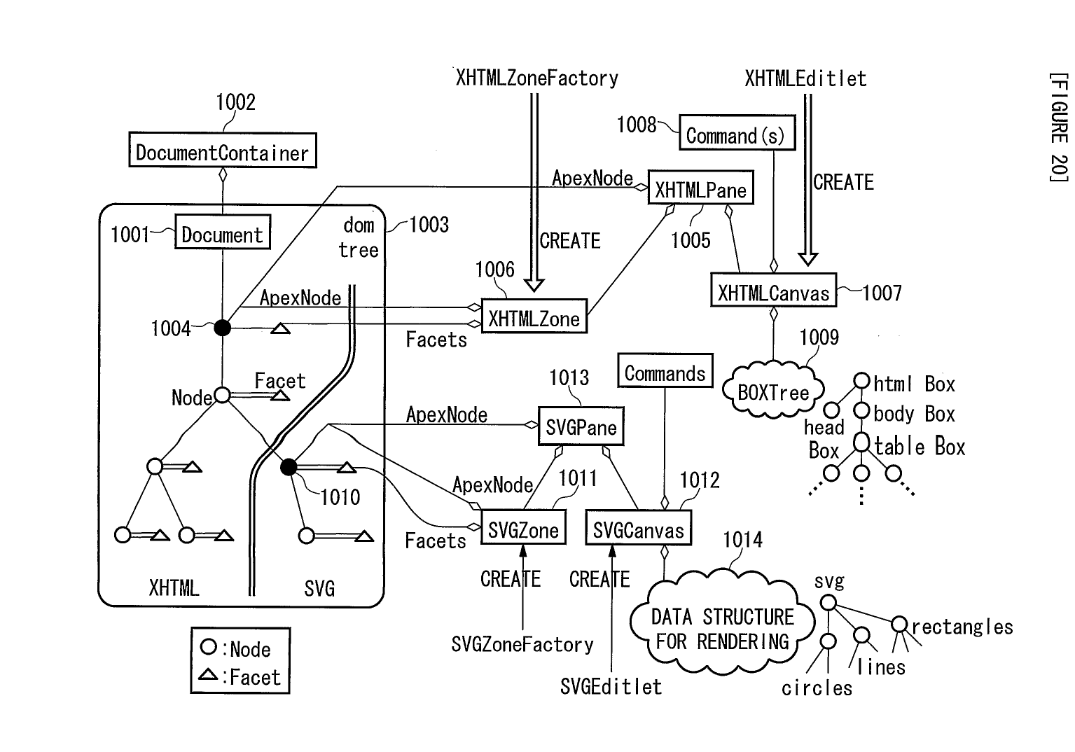

An example of a compound document and its various representations are discussed subsequently, using FIG. 20. The document used for this example includes both text and pictures. The text is represented using XHTML and the pictures are represented using SVG. FIG. 20 shows the MVC representation for the components of the document and the relation of the corresponding objects in detail. For this exemplary representation, the document 1001 is attached to a document container 1002 that holds the document 1001. The document is represented by a DOM tree 1003. The DOM 1003 tree includes an apex node 1004 and other nodes in descent, having corresponding facets as previously explained with respect to FIG. 19(a).

Apex nodes are represented by shaded circles. Non-apex nodes are represented by non-shaded circles. Facets, that are used to edit nodes, are represented by triangles and are attached to the corresponding nodes. Since the document has text and pictures, the DOM tree for this document includes an XHTML portion and an SVG portion. The apex node 1004 is the top-most node for the XHTML sub tree. This is attached to an XHTML pane 1005, which is the top most pane for the physical representation of the XHTML portion of the document. The apex node is also attached to an XHTML zone 1006, which is part of the DOM tree for the document 1001.

The facet 1041 corresponding to the node 1004 is also attached to the XHTML zone 1006. The XHTML zone 1006 is in turn attached to the XHTML pane 1005. An XHTML editlet creates an XHTML canvas 1007, which is the logical representation for the document. The XHTML canvas 1007 is attached to the XHTML pane 1005. The XHTML canvas 1007 creates a box tree 1009 for the XHTML component of the document 1001, the box tree being represented by appropriate combinations of a html Box, body Box, head Box and/or table Box as illustrated. Various commands 1008, which are required to maintain and render the XHTML portion of the document, are also added to the XHTML canvas 1005

Likewise the apex node 1010 for the SVG sub-tree for the document is attached to the SVG zone 1011, which is part of the DOM tree for the document 1001 that represents the SVG component of document. The apex node 1010 is attached to the SVG pane 1013, which is the top most pane for the physical representation of the SVG portion of the document. SVG canvas 1012, which represents the logical representation of the SVG portion of the document, is created by the SVG editlet and is attached to the SVG pane 1013. Data structures and commands 1014 for rendering the SVG portion of the document on the screen are attached to the SVG canvas 1012. For example, such a data structure could include circles, lines, rectangles, etc., as shown.

Parts of the representation for the example document, discussed in relation to FIG. 20 are further discussed in connection with the illustration in FIGS. 21(a) and 21(b), using the MVC paradigm described earlier. FIG. 21(a) provides a simplified view of the MV relationship for the XHTM component for the document 1001. The model is an XHTM zone 1103 for the XHTML component of the document 1001. Included in the XHTML zone tree are several nodes and their corresponding facets. The corresponding XHTML zone and the pane are part of the model (M) portion of the MVC paradigm. The view (V) portion of the MVC paradigm is the corresponding XHTML 1102 canvas and the box tree for the HTML component of the document 1001. The XHTML portion of the documents is rendered to the screen using the canvas and the commands contained therein. The events, such as keyboard and mouse inputs, proceed in the reverse directions as shown.

The source pane has an additional function, that is, to act as a DOM holder. FIG. 21(b) provides a vocabulary connection for the component of the document 1001 shown in FIG. 21(a). A source pane 1103, acting as the source DOM holder, contains the source DOM tree for the document. A connector tree 1104 is created by the connection factory, which in turn creates a destination pane 1105, that also serves as a destination DOM holder. The destination pane 1105 is then laid out as an XHTML destination canvas 1106 in the form of a box tree.

13. Relationships between Plug-in Subsystem, Vocabulary Connection and Connectors

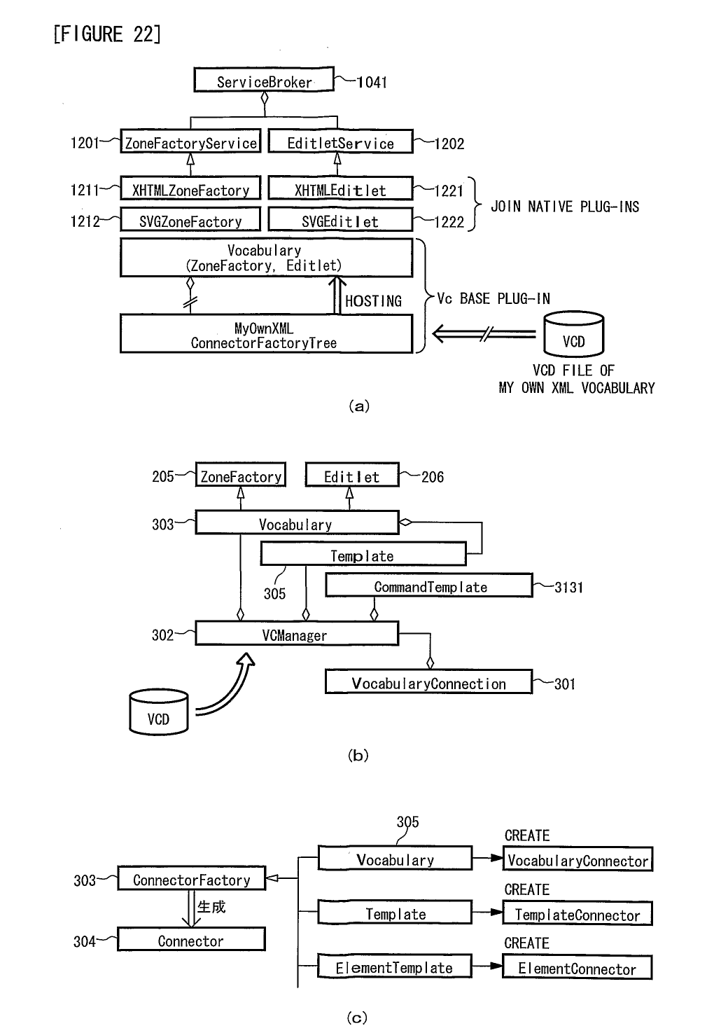

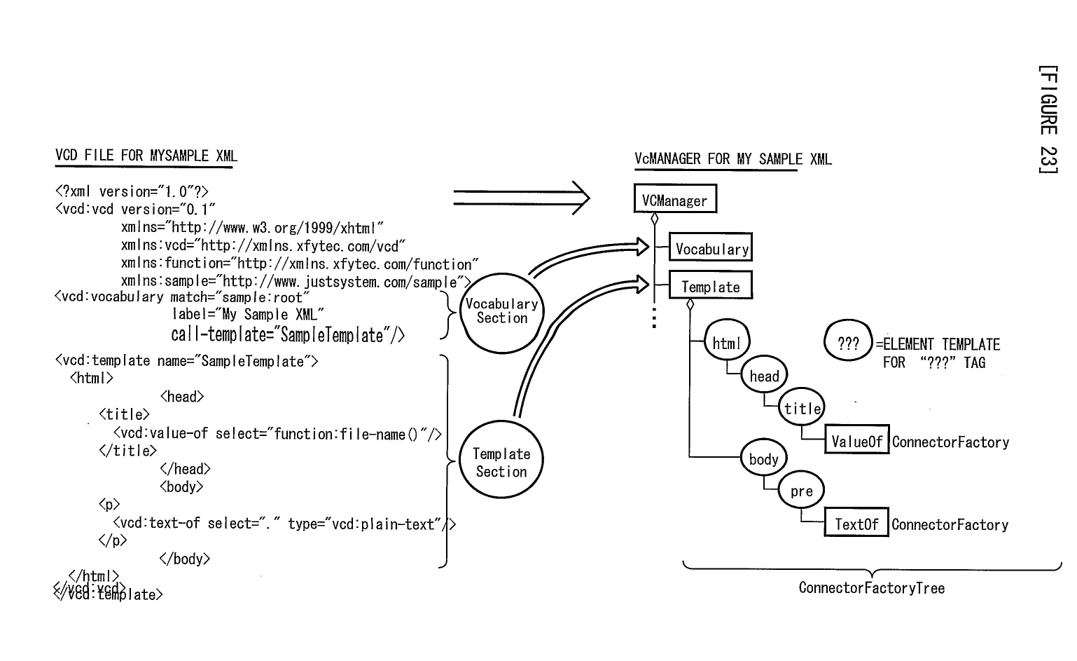

FIGS. 22(a)-(c) shows additional details related to the plug-in sub-system, vocabulary connections and connector, respectively. The plug-in subsystem system is used to add or exchange functions with the document processing and management system. The plug-in sub-system includes a service broker 1041. As illustrated in FIG. 22(a), a VCD file of “My Own XML vocabulary” is coupled to a VC Base plug-in, comprising a MyOwnXML connector factory tree and vocabulary (Zone Factory, Editlet). The zone factory service 1201, which is attached to the service broker 1041, responsible for creating zones for parts of the document. The editlet service 1202 is also attached to the service broker. The editlet service 1202 creates canvases corresponding to the nodes in the zone

Examples of zone factories are XHTML zone factory 1211 and SVG Zone factory 1212, which create XHTML zones and SVG zones, respectively. As noted previously in relation to an exemplary document, the textual component of the document could be represented by creating an XHTML zone and the pictures could be represented using the SVG zone. Examples of editlet services include XHTML editlet 1221 and SVG editlet 1222.

FIG. 22(b) shows additional details related to vocabulary connection, which as described above, is a significant feature of the document processing and management system that enables the consistent representation and display of documents in two different ways. The vocabulary connection manager 302, which maintains the connector factory 303, is part of the vocabulary connection subsystem and is coupled to the VCD to receive vocabulary connection descriptors and to generate vocabulary connection commands 301. As illustrated in FIG. 22(c), the connector factory 303 creates connectors 304 for the document. As discussed earlier, connectors view nodes in the source DOM and modify the nodes in the destination DOM to maintain consistency between the two representations.

Templates represent conversion rules for some nodes. In fact, a vocabulary connection descriptor file is a list of templates that represent some rules for converting an element or a set of elements that satisfy certain path or rules to other elements. The vocabulary template 305 and command template 3131 are all attached to the vocabulary connection manager 302. The vocabulary connection manager is the manager object of all sections in the VCD file. One vocabulary connection manager object is created for one VCD file.

FIG. 22(c) provides additional details related to the connectors. Connector factory 303 creates connectors from the source document. The connector factory is attached to vocabulary, templates and element templates and creates vocabulary connectors, template connectors and element connectors, respectively.

The vocabulary connection manager 302 maintains the connector factory 303. To create a vocabulary, the corresponding VCD file is read. The connector factory 303 is then created. This connector factory 303 is associated with the zone factory 205 that is responsible for creating the zones and the editlet service 206 that is responsible for creating the canvas.

The editlet service for the target vocabulary then creates a vocabulary connection canvas. The vocabulary connection canvas creates nodes for the destination DOM tree. The vocabulary connection canvas also creates the connector for the apex element in the source DOM tree or the zone. The child connectors are then created recursively as needed. The connector tree is created by a set of templates in the VCD file.

The templates in turn are the set of rules for converting elements of a markup language into other elements. For example, each template is matched with the source DOM tree or zone. In case of an appropriate match, an apex connector is created. For example, a template “A/*/D” watches all the branches of the tree starting with a node A and ending with a node D, regardless of what the nodes are in between. Likewise “//B” would correspond to all the “B” nodes from the root.

14. Example of a VCD File Related Connector Trees

An example explaining the processing related to a specific document follows. A document titled MySampleXML is loaded into the document processing system. FIG. 23 shows an example of VCD script using vocabulary connection manager and the connector factory tree for the file MySampleXML. The vocabulary section, the template section within the script file and their corresponding components in the vocabulary connection manager are shown. Under the tag “vcd:vocabulary” the attribute match=“sample:root”, label=“MySampleXML” and call-template=“sampleTemplate” are provided.

Corresponding to this example, the vocabulary includes apex element as “sample:root” in the vocabulary connection manager for MySampleXML. The corresponding UI label is “MySampleXML. In the template section the tag is vcd:template and the name is “sample template.”

15. Detailed Example of how a File is Loaded into the System

FIGS. 24-28 show a detailed description of loading the document MySampleXML. In step 1, shown in FIG. 24(a), the document is loaded from storage 1405. The DOM service creates a DOM tree and the document manager 1406 a corresponding document container 1401. The document container is attached to the document manager 1406. The document includes a subtree for XHTML and MySampleXML. The XHTML apex node 1403 is the top-most node for XHTML with the tag xhtml:html. On the other hand, mysample Apex node 1404 corresponds to mySampleXML with the tag sample:root.

In step 2, shown in FIG. 24(b) the root pane creates XTML zones, facets and canvas for the document. A pane 1407, XHTML zone 1408, XHTML canvases 1409 and a box tree 1410 are created in correspondence with the apex node 1403 and other nodes along with their related facet, in steps 1-5, according to the relationships as illustrated in the Figure.

In step 3, shown in FIG. 24(c), the XHTML zone finds a foreign tag “sample:root” and creates a sub pane from a region on the html canvas.

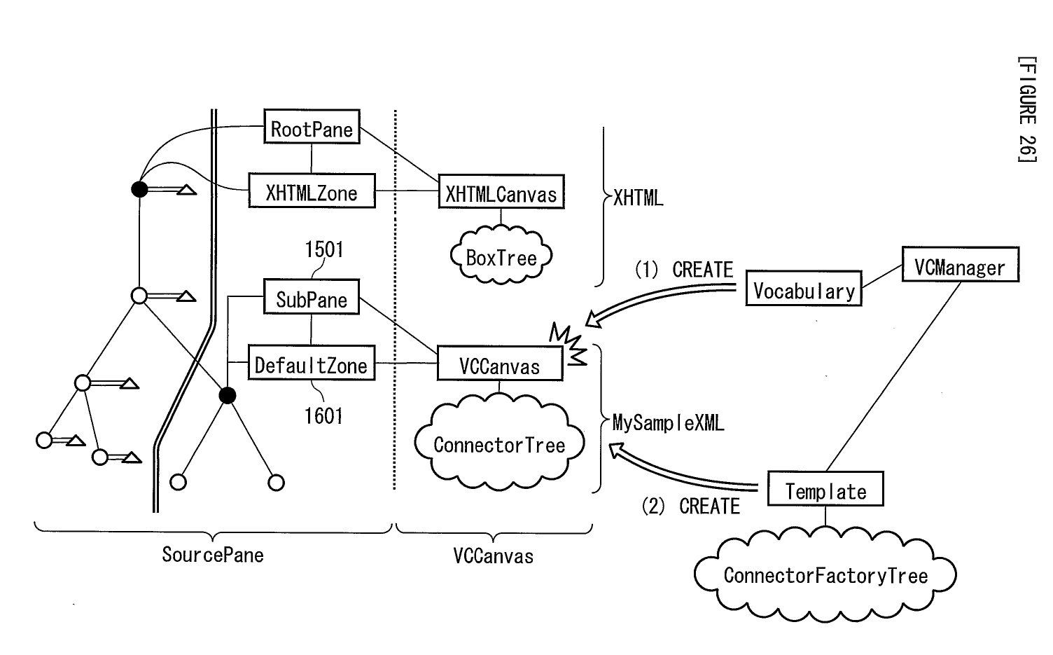

FIG. 25 shows step 4, where the sub pane 1501 gets a corresponding zone factory that can handle the “sample:root” tag and create appropriate zones. Such a zone factory will be in a vocabulary that can implement the zone factory. It includes the contents of the vocabulary section in MySampleXML.

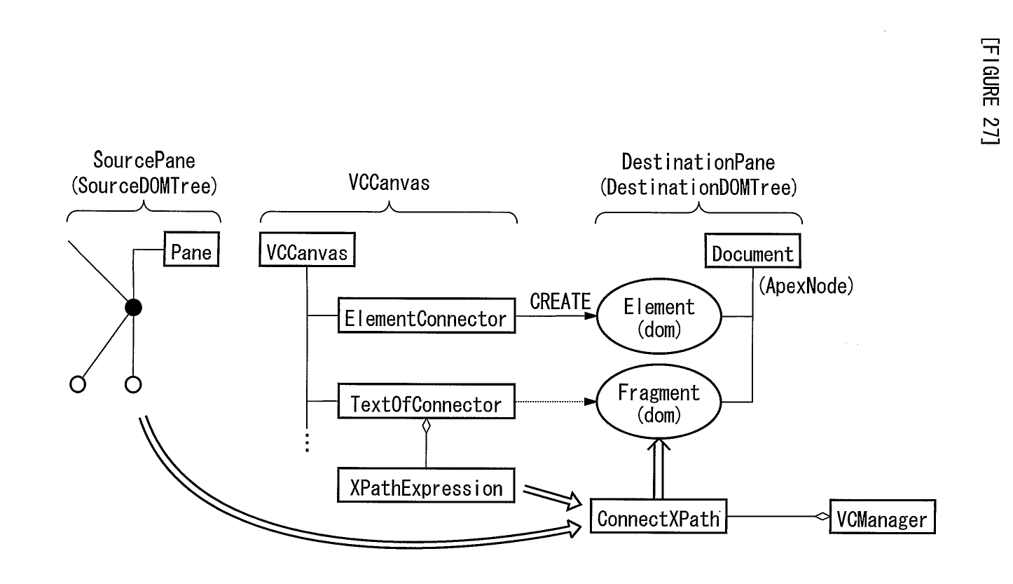

FIG. 26 shows step 5, where vocabulary corresponding to MySampleXML, and in connection with the VC Manager, creates a default zone 1601. A corresponding editlet is created and provided to sub pane 1501 to create a corresponding canvas. The editlet creates the vocabulary connection canvas. It then calls the template section, to which the connector factory tree is also coupled. The connector factory tree creates all the connectors, which are then made into the connector tree that forms a part of the VC Canvas. The relationship of the root pane and XHTML zone, as well as XHTML canvas and box tree for the apex node that relates to the XHTML content of the document is readily apparent from the previous discussion.

FIG. 27, on the basis of the correspondence among the Source DOM tree, VC canvas and Destination DOM tree as previously explained, shows step 6, where each connector then creates the destination DOM objects. Some of the connectors include xpath information. The xpath information includes one or more xpath expressions that are used to determine the subsets of the source DOM tree that need to be watched for changes/modifications.

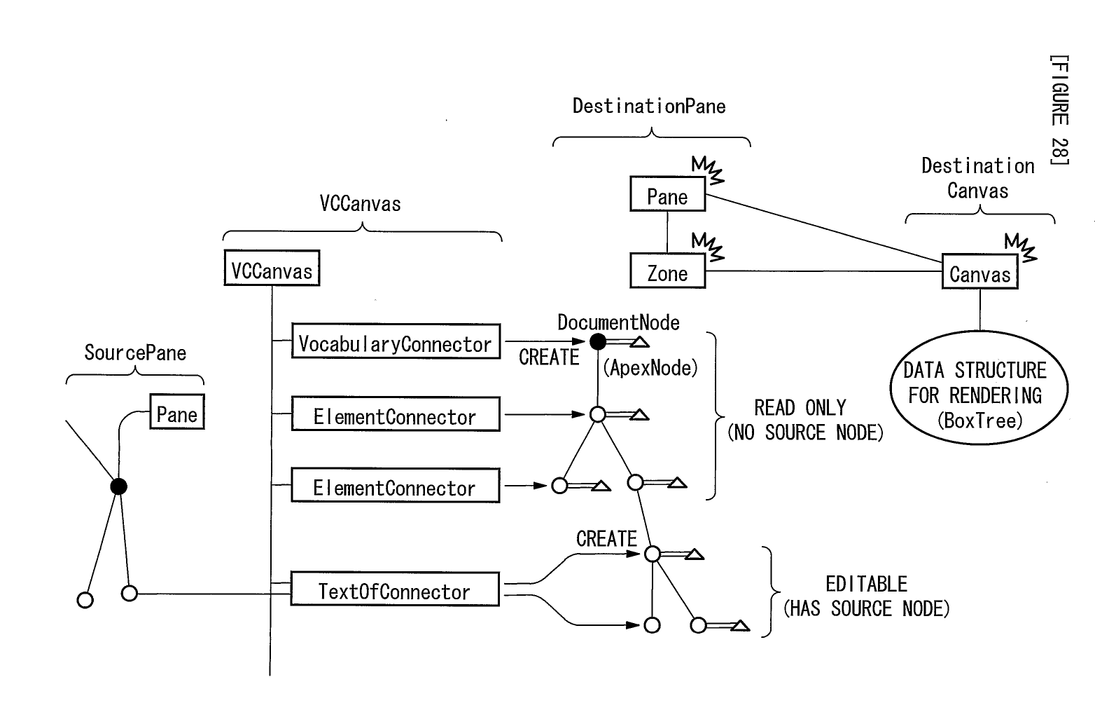

FIG. 28, according to the source, VC and destination relationship, shows step 7, where the vocabulary makes a destination pane for the destination DOM tree from the pane for the source DOM. This is done based on the source pane. The apex node of the destination tree is then attached to the destination pane and the corresponding zone. The destination pane is then provided with its own editlet, which in turn creates the destination canvas and constructs the data structures and commands for rendering the document in the destination format.

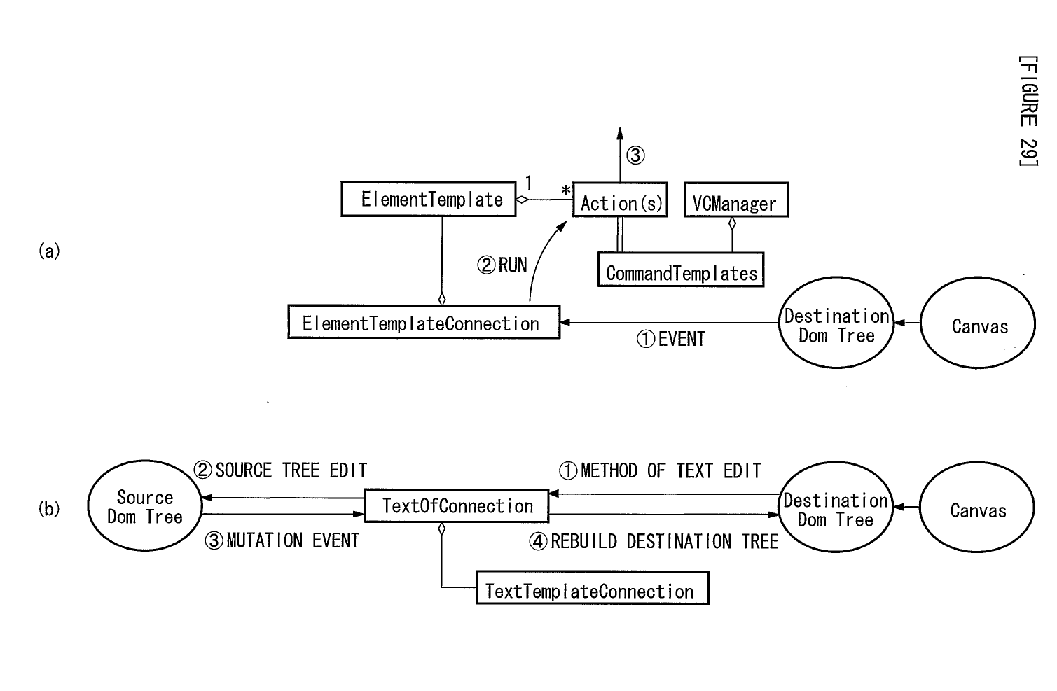

FIG. 29(a) shows a flow of an event, which has taken place on a node having no corresponding source node and dependent on a destination tree alone. In a first step, events acquired by a canvas such as a mouse event and a keyboard event pass through a destination tree and are transmitted to ElementTemplateConnector. ElementTemplateConnector does not have a corresponding source node, so that the transmitted event is not an edit operation on a source node. In case the transmitted event matches a command described in CommandTemplate, ElementTemplateConnector executes a corresponding action in second and third steps. Otherwise, ElementTemplateConnector ignores the transmitted event.

FIG. 29(b) shows a flow of an event, which has taken place on a node of a destination tree that is associated with a source node by TextOfConnector. TextOfConnector acquires a text node from a node specified by XPath of a source DOM tree and maps the text node to a node of the destination DOM tree. Events acquired by a canvas such as a mouse event and a keyboard event pass through a destination tree and are transmitted to TextOfConnector in a first step. TextOfConnector maps the transmitted event to an edit command of a corresponding source node and stacks the command in a queue 1053. The edit command is a set of API calls of DOM executed via a facet. When the command stacked in a queue is executed, a source node is edited in a second step. When the source node is edited, a mutation event is issued in a third step and TextOfConnector registered as a listener is notified of the modification to the source node. TextOfConnector rebuilds a destination tree in a fourth step so as to reflect the modification to the source node on the corresponding destination node. In case a template including TextOfConnector includes a control statement, such as “for each” and “for loop”, ConnectorFactory reevaluates the control statement. After TextOfConnector is rebuilt, the destination tree is rebuilt.

This embodiment proposes a technology to dispatch an appropriate processing unit or system in processing a document.

As described with reference to FIG. 24(a), when a document is loaded and a DOM tree is generated, an apex node processing unit is selected. As described with reference to FIG. 19(a), an apex node is passed to a root pane, and a processing unit, which can process the apex node, is selected by the pane owner.

The pane owner previously registers the entries of namespace and apex node element names which can be processed by each processing unit for a vocabulary plug-in or a VCD file present in the system, and selects an appropriate processing unit based on the namespace and element name of apex node passed from pane. The selected processing unit provides a zone factory and an editlet, and a zone and a canvas are respectively generated therefrom. The flow of this processing has already been described with reference to FIGS. 19(a) and 24(a).

When a zone encounters a node, which is unknown to the zone, that is, to which the zone cannot attach a facet, while the zone is attempting to attach a facet to a node, the zone cannot process this node. The zone may ignore this node or may delegate processing of this node to another processing unit. In the latter case, the zone returns this node to the pane. The pane generates a sub pane for a zone for which the node is the apex node, and returns the node and sub pane to a parent. The pane owner selects a processing unit, which can process this node. In this way, at least one processing unit may be allocated to each node in a DOM tree so that all nodes in the DOM tree may be processed using the allocated processing units.

A processing unit is selected based on the namespace and element name of an apex node. The attribute name or attribute value of apex node may be considered as well. A global attribute specified to the apex node may be considered as well. As an attribute or a global attribute of the apex node, a candidate processing unit to be selected may be explicitly specified. A table listing element, which can be processed by a processing unit, may be provided for selection of a processing unit, which can process elements below the apex node. Further, information on ancestor nodes of the apex node may be considered. In this regard, any node on the DOM tree that is a descendent or lateral correspondent with a subject node can be referred as an “ancestor” or “descendant.” For example a node can refer to a brother/sister of its ancestor.

When a global attribute of another vocabulary is specified to an element of a vocabulary, a processing unit for one vocabulary alone may fail to process the vocabulary. In order to solve this problem, for example in case a global attribute is specified, a processing unit for a global attribute may be selected and loaded in combination with a processing unit for a vocabulary to which the apex node belongs. In such case, both the global attribute processing unit and the apex node processing unit may be processed in parallel, processed alternately, or processed selectively depending on a variety of factors and in accordance with one or more allocation algorithms.

In case a plurality of processing units are selected as capable of processing, a selection instruction from the user may be accepted, or an appropriate processing unit may be determined by referring to a historical record. For example, for a user who continuously uses a processing unit of a particular vendor, the processing unit for the vendor may be selected on a first priority basis.

While, in the above example, a zone encountering a node which it cannot process delegates processing of the node to another processing unit, a node which can process the node may also delegate processing of the node to another processing unit. For example, when an XHTML processing unit processes an XHTML document, in case another processing unit to process a table is loaded into the system, processing of table elements may be delegated to the other processing unit. In case a node, which a processing unit can process, is nested in a DOM tree, the selected processing unit may search for ancestor nodes to check for nodes, which it can process and specify the highest-rank node, which it can process as a new apex node. The processing unit may determine whether to delegate processing to another processing unit on a per node basis.

In case a plurality of processing units can process a node, a condition to give a first priority to a processing unit to be selected may be previously set or an inquiry may be issued to the user as to which a processing unit is selected. A condition to determine an optimum combination of processing units in case a plurality of tag sets are included in a document, may be set beforehand in an allocation algorithm. For example, each element related to a node in a corresponding DOM tree may be assigned a candidate processing unit and a combination of processing units may be selected to minimize the boundaries of processing units. For example, assume that Processing System A can process tags a and b, Processing System B can process tags b, d and e, and Processing System C can process tags a, c and e, when a document to be processed includes tabs a, c, d and e in descending order from the highest rank, the highest-rank tag “a” can be processed by Processing System A or C, tab “c” by Processing System C, tag “d” by Processing System B, and tag “e” by Processing System B or C, respectively. Thus, Processing System C is assigned to the tags “a” and “c” and Processing System B is assigned to the tags “d” and “e”.

Other considerations in allocating a processing unit may include optimization of resource consumption or optimizing response performance of the overall system. In other words, the selection of processing units may be based on one or more allocation algorithms and/or criteria. Moreover, where multiple candidate units can process a given node, the processing may be performed by multiple processing units in parallel, but only selected one or more of the results may be displayed to a user, while others are simply run in the background.

A zone boundary does not have to match a namespace boundary. A zone boundary does not have to match a tag set boundary. For example, when a vocabulary plug-in, which can process both XHTML and SVG, is provided, a compound document including XHTML and SVG can be processed by using a single vocabulary plug-in. A processing unit may be provided which processes only the table portion of XHTML in a spreadsheet application fashion. In other words, a processing unit may be capable of processing a plurality of vocabularies, tag sets and markup languages.

Thus, as is clear from the foregoing capabilities, a fragment of a compound document may be processed by plural processing units, and those units may mutually share a capability of processing common vocabularies and/or tags. Moreover, there may be a common or shared capability in those processing units to process an undo procedure. Such a common capability may be operative to perform a focus management and a position management on a common display medium, and may be adapted to processes a suspension and a resumption of a processing of a compound document. Such a common capability may be operative with cuing of a command.

A processing unit also may be selected based on the file name or extension of a document file. Further, a processing unit may be selected based on the processing details. For example, in the case of browsing a document, a processing unit dedicated to browsing may be selected. In case a document is edited, a processing unit capable of editing may be selected.

In this way, by plugably assigning an appropriate processing unit after loading a document, a document including an arbitrary combination of vocabularies can be properly processed. Even after the document is loaded, the current processing unit may be replaced with another.

The invention has been described based on the embodiments, which are only explanatory. It is understood by those skilled in the art that there exist other various modifications to the combination of each component and process described above and that such modifications are encompassed by the scope of the invention.

While the above embodiments have been explained using an example in which XML documents are to be processed, the document processing apparatus 20 according to the embodiments may similarly be capable of processing documents described in other markup languages such as SGML and HTML.

1. A document processing apparatus operative to process a compound document, having one or more vocabularies, for display to a user for editing and to facilitate editing of the compound document, comprising:
a plurality of processing units, each of which is operative to process a document or part thereof on the basis of a predetermined tag set, and
a display processing apparatus responsive to said plurality of processing units, for preparing said compound document for display on a single display medium to the user.

2. The document processing apparatus according to claim 1, further comprising a vocabulary converter, operative in a case where said compound document includes a portion defined by a tag set that is not to be processed by at least one of said plurality of processing units, to map the tag set for said portion to a tag set which can be processed by at least one of said plurality of processing units.

3. The document processing apparatus according to claim 1, wherein, in a case where said compound document includes a portion defined by a tag set that is not to be processed by at least one of said plurality of processing units, said document processing apparatus presents said portion in one of a source display or tree display.

4. The document processing apparatus according to any one of claims 1 through 3, wherein said display processing apparatus is operative to present an edit menu that corresponds to a portion of the compound document that is to be edited.

5. The document processing apparatus according to any one of claims 1 through 4, wherein, for a compound document comprising plural types of tag sets, a processing unit operative to process data for a first type of tag set is operative to access the data of a portion of said compound document that consists of a second tag set different from said first tag set.

6. The document processing apparatus according to any one of claims 1 through 4, wherein said compound document is represented by plural elements, each containing selection information, and one of said plurality of processing units, which processes an element included in said document, is selected as a selected processing unit, based on the selection information obtained from the element.

7. The document processing apparatus according to claim 6, wherein the selection information obtained from said element includes at least one of an element name and a namespace of the element.

8. The document processing apparatus according to claim 6 or 7, wherein the selection information obtained from said element includes at least one of an attribute name or an attribute value of an attribute included in the element.

9. The document processing apparatus according to any one of claims 6 through 8, wherein a processing unit selected to process an element sequentially determines, from the element toward descendants of the element, whether elements can be processed, and when there is an element which cannot be processed, the processing unit is operative to at least delegate processing of the element to another processing unit as a selected processing unit or refrain from processing of the element.

10. The document processing apparatus according to claim 9, wherein, in case said processing unit can process an element and another processing unit can also process the element, said processing unit can select whether processing of the element is made by said processing unit or said another processing unit as a selected processing unit.

11. The document processing apparatus according to any one of claims 1 through 4, further comprising a management unit for generating and managing data of a format which conforms to a document object model defined to provide an access method used to process said document as data,
wherein said management unit generates document object model data corresponding to said document, and
wherein a processing unit is selected as a selected processing unit based on information obtained from an apex node of a sub tree of a DOM tree representing said document object model data.

12. The document processing apparatus according to claim 11,
wherein said selected processing unit adds, from the apex node toward the descendants of the apex node, an object including an interface specific to the node, and delegates to another processing unit a processing of a node to which said object cannot be added.

13. The document processing apparatus according to any one of claims 6 through 12, wherein at least one of said processing units is operative to process a plurality of tag sets.

14. A document processing method for processing a compound document, having one or more vocabularies, to facilitate editing of the compound document, comprising:
providing a plurality of processings, each of which is for processing a document or part thereof on the basis of a predetermined tag set for display;
processing said plurality of tag sets of said document for display on a common display medium; and
responding to user inputs to edit said document.

15. A computer program product which is operative to control a computer to implement a method for processing a compound document, having one or more vocabularies, to facilitate editing of the compound document, comprising:
providing a plurality of processings, each of which is for processing a document or part thereof on the basis of a predetermined tag set for display;
processing said plurality of tag sets of said document for display on a common display medium; and
responding to user inputs to edit said document.

16. A method for editing and/or displaying a compound document having plural vocabularies, comprising:
loading said compound document to be processed,
generating a DOM tree from the compound document;
determining which one or more vocabularies describe the compound document by referring to at least one of a name space or element of the compound document;
if a vocabulary processing part corresponding to the vocabulary is available, operating said vocabulary processing part so as to display and/or edit the document;
if the vocabulary processing part is not available, determining whether or not a corresponding definition file exists, and
if the definition file exits, acquiring the definition file and generating a corresponding destination tree, so that the document is displayed and/or edited by a mapped processing part corresponding to said vocabulary.

17. The method according to claim 16, wherein, for each of a plurality of vocabularies, relevant portions of the compound document are displayed and/or edited by processing parts corresponding to the respective vocabularies.

18. The method according to claim 16, wherein, if the definition file does not exist, displaying a source or tree structure of the compound document and carrying out the editing in a display medium.

19. The method according to claim 17, wherein at least one portion of the compound document can be displayed and/or edited by plural processing parts.

20. The method according to claim 17, wherein at least two portions of the compound document can be displayed and/or edited by a common processing part.

21. A method of processing a compound document, having at least two tag sets and being dividable into separate fragments, for display to a user to facilitate rendering of the compound document, comprising:
logically separating said document according to said fragments;
allocating at least one respective processing part to each of at least two fragments;
separately processing at least two of said fragments, using at least one respective processing part, each said processing part being operative to process a predetermined tag set; and
displaying the result of processing said at least two fragments on a common editing display.

22. The method according to claim 21, further comprising:
representing said compound document in memory as a DOM tree having plural nodes; and
conducting said processing step as a modification of at least a portion of said DOM tree.

23. The method according to claim 22, wherein said DOM tree comprises plural element nodes and said separating step is conducted on the basis of information corresponding to at least one of said element nodes.

24. The method according to claim 23, wherein said information corresponding to said element node comprises at least one of a name space name and an element name

25. The method according to claim 23, further comprising:
allocating at least one processing part to each node in said DOM tree, and
wherein said processing step comprises processing all nodes in said DOM tree using said allocated processing parts.

26. The method according to claim 22, wherein a plurality of edit processing parts are allocated to a given node and said processing step using said plurality of processing parts is conducted for said given node; and
wherein said displaying step is conducted for at least one of said plural processing parts but is not conducted for at least one other of said plural processing parts.

27. The method according to claim 21, wherein said allocating step is conducted according to one of at least two allocation criteria.

28. The method according to claim 21, wherein at least one said processing part is selectable by a user.

29. The method according to claim 21, wherein said allocating step is based upon a processing part that optimizes resource consumption.

30. The method according to claim 21, wherein said allocating step is based upon the edit processing part that provides an optimum response performance.

31. The method according to claim 21, wherein said allocating step is based upon the two or more processing parts that are specified by a user beforehand.

32. The method according to claim 21, wherein said processing step comprises processing a fragment of the compound document with one of a respective processing part and non-respective processing parts by referring to a DOM Tree.

33. The method according to claim 32, wherein plural processing parts mutually share a common part.

34. The method according to claim 33, wherein the common part for plural processing parts is operative to process an undo procedure.

35. The method according to claim 33, wherein the common part for plural processing parts is operative with cuing of a command.

36. The method according to claim 33, wherein the common part for plural processing parts-is operative to perform a focus management and a position management on a common display medium.

37. The method according to claim 33, wherein the common part for plural processing parts is operative to processes a suspension and a resumption of a processing of a compound document.

38. The method according to claim 22, further comprising, if the allocating step cannot be conducted for all nodes using said plurality of processing parts, assigning a source display processing part to process the node for which there is no corresponding processing part.

39. The method according to claim 22, further comprising, if the allocating step cannot be conducted for all nodes by said plurality of processing parts, conducting processing to be allocated in an existing processing part by converting the structure into a part where the corresponding processing part does not exist.

40. The method according to claim 21, further comprising:
switching a part of the user interface at least according to the processing part that corresponds to a present edit on the common display medium.
